(19) United States
(12) Patent Application Publication
(10) Pub. No.: US 2018/0005274 A1
(43) Pub. Date: Jan. 4, 2018

(54) MANAGEMENT SYSTEM FOR HIGH VOLUME DATA ANALYTICS AND DATA INGESTION

(71) Applicant: Nanigans, Inc., Boston, MA (US)

(72) Inventors: Ric Calvillo, Chestnut Hill, MA (US); Claude Denton, Lexington, MA (US); Joshua Allen Breckman, Arlington, MA (US); Jonathan Palmer, Belmont, MA (US)

(73) Assignee: Nanigans, Inc., Boston, MA (US)

(21) Appl. No.: 15/704,891

(22) Filed: Sep. 14, 2017

Related U.S. Application Data
(63) Continuation-in-part of application No. 15/290,946, filed on Oct. 11, 2016.
Application No. 15/290,946 is a continuation-in-part of application No. 15/243,680, filed on Aug. 22, 2016.
Application No. 15/243,680 is a continuation-in-part of application No. 15/206,581, filed on Jul. 11, 2016.
Application No. 15/206,581 is a continuation-in-part of application No. 15/166,815, filed on May 27, 2016.
Application No. 15/206,581 is a continuation-in-part of application No. 15/166,852, filed on May 27, 2016.
Application No. 15/243,680 is a continuation-in-part of application No. 15/166,815, filed on May 27, 2016.
Application No. 15/166,815 is a continuation-in-part of application No. 15/166,852, filed on May 27, 2016.
Application No. 15/290,946 is a continuation-in-part of application No. 15/206,581, filed on Jul. 11, 2016.
Application No. 15/206,581 is a continuation-in-part of application No. 15/166,815, filed on May 27, 2016.
Application No. 15/166,815 is a continuation-in-part of application No. 15/166,852, filed on May 27, 2016.
(60) Provisional application No. 62/239,145, filed on Oct. 8, 2015.
(60) Provisional application No. 62/208,241, filed on Aug. 21, 2015.
(60) Provisional application No. 62/190,451, filed on Jul. 9, 2015.
(60) Provisional application No. 62/168,303, filed on May 29, 2015.
(60) Provisional application No. 62/239,145, filed on Oct. 8, 2015.
(60) Provisional application No. 62/208,241, filed on Aug. 21, 2015.
(60) Provisional application No. 62/190,451, filed on Jul. 9, 2015.
(60) Provisional application No. 62/168,303, filed on May 29, 2015.
(60) Provisional application No. 62/239,145, filed on Oct. 8, 2015.
(60) Provisional application No. 62/208,241, filed on Aug. 21, 2015.
(60) Provisional application No. 62/190,451, filed on Jul. 9, 2015.
(60) Provisional application No. 62/239,145, filed on Oct. 8, 2015.
(60) Provisional application No. 62/208,241, filed on Aug. 21, 2015.
(60) Provisional application No. 62/239,145, filed on Oct. 8, 2015.
(60) Provisional application No. 62/208,241, filed on Aug. 21, 2015.
(60) Provisional application No. 62/190,451, filed on Jul. 9, 2015.
(60) Provisional application No. 62/394,695, filed on Sep. 14, 2016.

(51) Int. Cl. G06Q 30/02; G06Q 50/00; G06F 3/0482

(52) U.S. Cl. CPC G06Q 30/0269; G06F 3/0482; G06Q 50/01

(57) ABSTRACT

A system is provided for ingesting existing advertising networks and/or advertising campaigns to enable centralized and consistent control. Various embodiments, are specially configured to enable users to capture the existing placement information (e.g., user interface design elements, execution rules, attribution information, etc.) and incorporate the existing ads or placements into build templates that facilitate management and/or modification of the placements by build group.

### RELATED APPLICATIONS

This Application claims the benefit under 35 U.S.C. §120 of U.S. application Ser. No. 15/290,946, entitled “SYSTEM FOR HIGH VOLUME DATA ANALYTIC INTEGRATION AND CHANNEL-INDEPENDENT ADVERTISEMENT GENERATION” filed on Oct. 11, 2016, which is herein incorporated by reference in its entirety. Application Ser. No. 15/290,946 claims the benefit under 35 U.S.C. §120 of U.S. application Ser. No. 15/243,680, entitled “SYSTEM FOR HIGH VOLUME DATA ANALYTICS AND DATA INGESTION” filed on Aug. 22, 2016, which is herein incorporated by reference in its entirety. Application Ser. No. 15/243,680 claims the benefit under 35 U.S.C. §120 of U.S. application Ser. No. 15/206,581, entitled “SYSTEM AND METHOD FOR ACCOUNT INGESTION” filed on Jul. 11, 2016, which is herein incorporated by reference in its entirety. Application Ser. No. 15/206,581 claims the benefit under 35 U.S.C. §120 of U.S. application Ser. No. 15/166,815, entitled “GRAPHICAL USER INTERFACE FOR HIGH VOLUME DATA ANALYTICS” filed on May 27, 2016, which is herein incorporated by reference in its entirety. Application Ser. No. 15/166,815 claims priority under 35 U.S.C. §119(e) to U.S. Provisional Application Ser. No. 62/239,145, entitled “SYSTEM FOR HIGH VOLUME DATA ANALYTIC INTEGRATION AND CHANNEL-INDEPENDENT ADVERTISEMENT GENERATION” filed on Oct. 8, 2015, which is herein incorporated by reference in its entirety. Application Ser. No. 15/166,815 claims priority under 35 U.S.C. §119(e) to U.S. Provisional Application Ser. No. 62/208,241, entitled “SYSTEM FOR HIGH VOLUME DATA ANALYTICS AND DATA INGESTION” filed on Aug. 21, 2015, which is herein incorporated by reference in its entirety. Application Ser. No. 15/166,815 claims priority under 35 U.S.C. §119(e) to U.S. Provisional Application Ser. No. 62/190,451, entitled “SYSTEM AND METHOD FOR ACCOUNT INGESTION” filed on Jul. 9, 2015, which is herein incorporated by reference in its entirety. Application Ser. No. 15/166,815 claims priority under 35 U.S.C. §119(e) to U.S. Provisional Application Ser. No. 62/168,303, entitled “GRAPHICAL USER INTERFACE FOR HIGH VOLUME DATA ANALYTICS” filed on May 29, 2015, which is herein incorporated by reference in its entirety. Application Ser. No. 15/206,581 claims the benefit under 35 U.S.C. §120 of U.S. application Ser. No. 15/166,852, entitled “SYSTEM FOR HIGH VOLUME DATA ANALYTIC INTEGRATION AND CHANNEL-INDEPENDENT ADVERTISEMENT GENERATION” filed on May 27, 2016, which is herein incorporated by reference in its entirety. Application Ser. No. 15/166,852 claims priority under 35 U.S.C. §119(e) to U.S. Provisional Application Ser. No. 62/239,145, entitled “SYSTEM FOR HIGH VOLUME DATA ANALYTIC INTEGRATION AND CHANNEL-INDEPENDENT ADVERTISEMENT GENERATION” filed on Oct. 8, 2015, which is herein incorporated by reference in its entirety. Application 15/166,852 claims priority under 35 U.S.C. § 119(e) to U.S. Provisional Application Ser. No. 62/208,241, entitled “SYSTEM FOR HIGH VOLUME DATA ANALYTICS AND DATA INGESTION” filed on Aug. 21, 2015, which is herein incorporated by reference in its entirety. Application 15/166,852 claims priority under 35 U.S.C. §119(e) to U.S. Provisional Application Ser. No. 62/190,451, entitled “SYSTEM AND METHOD FOR ACCOUNT INGESTION” filed on Jul. 9, 2015, which is herein incorporated by reference in its entirety. Application Ser. No. 15/166,852 claims priority under 35 U.S.C. §119(e) to U.S. Provisional Application Ser. No. 62/168,303, entitled “GRAPHICAL USER INTERFACE FOR HIGH VOLUME DATA ANALYTICS” filed on May 29, 2015, which is herein incorporated by reference in its entirety. Application Ser. No. 15/206,581 claims priority under 35 U.S.C. §119(e) to U.S. Provisional Application Ser. No. 62/239,145, entitled “SYSTEM FOR HIGH VOLUME DATA ANALYTIC INTEGRATION AND CHANNEL-INDEPENDENT ADVERTISEMENT GENERATION” filed on Oct. 8, 2015, which is herein incorporated by reference in its entirety. Application Ser. No. 15/206,581 claims priority under 35 U.S.C. §119(e) to U.S. Provisional Application Ser. No. 62/208,241, entitled “SYSTEM FOR HIGH VOLUME DATA ANALYTICS AND DATA INGESTION” filed on Aug. 21, 2015, which is herein incorporated by reference in its entirety. Application Ser. No. 15/206,581 claims priority under 35 U.S.C. §119(e) to U.S. Provisional Application Ser. No. 62/190,451, entitled “SYSTEM AND METHOD FOR ACCOUNT INGESTION” filed on Jul. 9, 2015, which is herein incorporated by reference in its entirety. Application Ser. No. 15/243,680 claims the benefit under 35 U.S.C. §120 of U.S. application Ser. No. 15/166,815, entitled “GRAPHICAL USER INTERFACE FOR HIGH VOLUME DATA ANALYTICS” filed on May 27, 2016, which is herein incorporated by reference in its entirety. Application Ser. NO. 15/243,680 claims the benefit under 35 U.S.C. §120 of U.S. application Ser. No. 15/166,852, entitled “SYSTEM FOR HIGH VOLUME DATA ANALYTIC INTEGRATION AND CHANNEL-INDEPENDENT ADVERTISEMENT GENERATION” filed on May 27, 2016, which is herein incorporated by reference in its entirety. Application Ser. No. 15/243,680 claims priority under 35 U.S.C. §119(e) to U.S. Provisional Application Ser. No. 62/239,145, entitled “SYSTEM FOR HIGH VOLUME DATA ANALYTIC INTEGRATION AND CHANNEL-INDEPENDENT ADVERTISEMENT GENERATION” filed on Oct. 8, 2015, which is herein incorporated by reference in its entirety. Application Ser. No. 15/243,680 claims priority under 35 U.S.C. §119(e) to U.S. Provisional Application Ser. No. 62/208,241, entitled “SYSTEM FOR HIGH VOLUME DATA ANALYTICS AND DATA INGESTION” filed on Aug. 21, 2015, which is herein incorporated by reference in its entirety. Application Ser. No. 15/290,946 claims the benefit under 35 U.S.C. §120 of U.S. application Ser. No. 15/206,581, entitled “SYSTEM AND METHOD FOR ACCOUNT INGESTION” filed on Jul. 11, 2016, which is herein incorporated by reference in its entirety. Application Ser. No. 15/290,946 claims the benefit under 35 U.S.C. §120 of U.S. application Ser. No. 15/166,815, entitled “GRAPHICAL USER INTERFACE FOR HIGH VOLUME DATA ANALYTICS” filed on May 27, 2016, which is herein incorporated by reference in its entirety. Application Ser. No. 15/290,946 claims the benefit under 35 U.S.C. §120 of U.S. application Ser. No. 15/166,852, entitled “SYSTEM FOR HIGH VOLUME DATA ANALYTIC INTEGRATION AND CHANNEL-INDEPENDENT ADVERTISEMENT GENERATION” filed on May 27, 2016, which is herein incorporated by reference in its entirety. Application Ser. No. 15/290,946 claims priority under 35 U.S.C. §119(e) to U.S. Provisional Application Ser. No. 62/239,145, entitled “SYSTEM FOR HIGH VOLUME DATA ANALYTIC INTEGRATION AND CHANNEL-INDEPENDENT ADVERTISEMENT GENERATION” filed on Oct. 8, 2015, which is herein incorporated by reference in its entirety. Application Ser. No. 15/290,946 claims priority under 35 U.S.C. §119(e) to U.S. Provisional Application Ser. No. 62/208,241, entitled “SYSTEM FOR HIGH VOLUME DATA ANALYTICS AND DATA INGESTION” filed on Aug. 21, 2015, which is herein incorporated by reference in its entirety. Application Ser. No. 15/290,946 claims priority under 35 U.S.C. §119(e) to U.S. Provisional Application Ser. No. 62/190,451, entitled “SYSTEM AND METHOD FOR ACCOUNT INGESTION” filed on Jul. 9, 2015, which is herein incorporated by reference in its entirety. This Application claims priority under 35 U.S.C. §119(e) to U.S. Provisional Application Ser. No. 62/394,695, entitled “MANAGEMENT SYSTEM FOR HIGH VOLUME DATA ANALYTICS AND DATA INGESTION” filed on Sep. 14, 2016, which is herein incorporated by reference in its entirety.

### BACKGROUND

A variety of platforms exist to manage complex advertising networks. Under many conventional approaches no unified management system completely integrates management systems having different formats, different analysis metrics, and different functionality or control operations. Further, portability of existing networks is severely limited by the differing format and differing operations established to manage the existing network.

### SUMMARY

It is realized that a need exists for an advertisement management system that provides consistent management interfaces for a variety of different formats, different analysis metrics, different functionality, and different control operations executable at various content host systems. It is further realized that bringing existing advertisements (even those previously created in a consistent management environment as well as advertisements created with other system and/or other management systems) under the control of operational templates (e.g., build templates) further improves over conventional systems. According to some embodiments, build templates are specifications of base properties for a multitude (e.g., tens, hundreds, thousands, etc.) of advertisements (also referred to as placements). Using build templates, the consistent management system enables users to control large or small groups of placements (e.g., changing properties, definitions, parameters of the entire group). Further, the consistent management system is configured to capture existing placements, grouping those placements, and enabling users to modify those placements as groups.

According to one aspect, a consistent management system is provided that enables ingestion of existing placements built on disparate systems to be managed, controlled, updated and executed. Ingestion operations can also be executed on placement already existing on the system, to bring those placements under group based control. In one embodiment, the system can map existing placements and respective properties into one or more build templates. The build templates can then be manipulated to control, modify, and/or update associated placements.

For example, the system can map existing placements into dynamic data structures of the management system to enable consistent control and aggregate control operations over dynamic groupings. In another example, the management system ingests existing placements into the management system, mapping external placements into the dynamic data structures of the management system. The external originated placements can then be managed under the same control operations provided on the system, including, for example, group based control functions. In one example, the external placements are captured based on the existing properties for the existing ads (e.g., creative information, bid information, audience information, etc.). Those properties (e.g., data attributes defining the details of the placement and any functions associated with them) are then used to generate build templates. The build templates provide a specification of all the details necessary to create those ads from scratch on the system. Thus, as part of creating the build template from groups of ingested placements, the system clusters ingested ads into groupings that can be defined by a respective template. According to one embodiment, the system is configured to decompose the ingested placements into the individual elements that make up the placement. The decomposition can be simulated as execution of the process of generating a placement, but in reverse. In some examples, the system creates new templates as needed so that each placement is represented by a build template. In further embodiments, the system analyzes the properties of the ingested placements to establish a minimum number of build templates required to generate the ingested placements.

According to other embodiments, the management system can also be configured to maintain execution mappings from internal management functions to functions on third party content systems. In some embodiments, automated functions on the consistent management system are translated into executable functions on the third party content system (e.g., bid up, bid down, pause ad, stop ad, etc.) from which external placements were ingested. Some advantages include finer granularity of control in the consistent management environment. For example, the data structures of the system are tied to automatic control and optimization functions and the additional levels described by the data structures enable improved control and enable functions unavailable in other systems.

In other embodiments, any automatic operations (e.g., changed bids, edited creative parameters, audience targeting, etc.) are also tied to any associated build templates, such that, the build templates themselves are modified in conjunction with the underlying ads that are being controlled. Maintaining this linkage provides significant advantages over conventional approaches, reducing the complexity of managing hundreds, thousands, and even hundreds of thousands of individual placements. In further embodiments, the system can be configured to automatically generate new build templates based on changes to the underlying placements.

According to another embodiment, ingestion of placements can also be configured to work on internally created placements that have, for example, diverged from an existing build template where the linkage has been broken or as in previous versions of the system and other conventional systems, where linkage to build templates was not maintained or created in the first instance.

In another aspect, conventional management systems enable creation and control of multitudes of placements, however, as the created placements diverge from their original configuration, the associated between group builds and existing placements often fails over time or is not maintained. In one example, a build template may have generated 100 placements for execution, and deployed those 100 placements on content delivery systems (e.g., specific advertising channels like FACEBOOK). Over time, those 100 adds morph, based on performance metrics (e.g., individual placements within the group are decommissioned, retired, deleted, etc.), and/or automatic control functions that are executed to optimize those placements. In other examples, individual ads in the group are modified via automatic audience tailoring, and for example, better performing ads can be automatically bid up in value, and lower performing ads automatically bid down, paused, or terminated. When considering hundreds of thousands of placements, the delta between placements as they were created and as they exist currently can overwhelm conventional management systems. In conventional approaches, the inability to manage groups of the placements as the exist currently results in significant inefficiency on those systems.

For example, in order to act on these build groups various conventional approaches require that the build group be manipulated from the creation based configuration (i.e., their original configuration). In some examples, this translates into recreating even decommissioned placements. Recreating deleted, stopped, and decommissioned placements is a waste of computer resources (e.g., in terms of wasted processing cycles, memory load, and storage requirements induced by recreating these failed objects). Further the terminated placements then need to be decommissioned again resulting in further waste. In other examples, smaller changes may be even more common and in aggregate can have an even greater impact on unnecessary computation and processing—for example, a user may have to review the recreated build group and each individual ad to identify and implement changes in bidding strategy, revisions to the ad copy (e.g., verbiage of the ad), audience targeting, advertising channel (e.g., specific social media platform, etc.). The operations executed by the system in setting represent pure waste when compared to systems that can maintain linkage to the placements as they are modified or alternative, where the system can regenerated build templates that reflect the current state or those placements.

Various embodiments of the consistent management system overcome the inefficiency of these conventional approaches and reduce the computational complexity of managing the constantly changing placements by enabling group changes via build groups. In one example, the system is configured to ingest existing placements (both external and internal placements (i.e., created originally on the consistent management system)). As part of the ingestion process, the consistent management system is configured to re-link placements to build groups and track the underlying changes to individual elements of the build group. According to one embodiment, this approach enables the consistent management system to capture and control build groups dynamically (e.g., build groups with individual placements that are deleted, modified, paused, bid up, bid down, etc.) without the inefficiencies of conventional systems.

According to various aspects, a system is provided for ingesting existing advertising networks and/or advertising campaigns. According to some embodiments, advertising networks and/or campaigns comprise thousands of digital based placements or placements, that are constantly being called by content provider systems, constantly being delivered to hundreds of thousands of end user computer systems, accompanied by constantly updating reporting data and analytic data to manage the placements. Various embodiments, are specially configured to enable users to capture existing placement information (e.g., user interface design elements, execution rules, attribution information, etc.) and translate the existing digital objects from a variety of platforms, formats, etc. into a commonly managed interface.

In one embodiment, the system is specially configured to capture existing advertisements, advertising campaigns, or any existing marketing accounts (e.g., from a first second, third, forth, etc. platform (e.g., each having different formats and execution rules)), and aggregate, translate, and/or associate the existing information into a single automated management system. Various embodiments of the ingestion subsystem enable users to port large advertising campaigns or large volumes of advertisements into an automated management system. According to some implementations, it is also realized that a need exists not only for porting advertisements or advertising campaigns between service providers, but also a need exists to effectively port historic data generated by different service providers. According to one embodiment, in order for such transitions to be effective, various embodiments enable immediate use of the ported historic data to optimize and/or automate execution of advertisements and/or advertising networks and management functions (e.g., end spend, modify advertisement, bid up position, etc.).

In various embodiments, the ingestion subsystem is configured to capture and translate advertising information from a first provider format into a destination format associated with an automated management and performance analysis system. The destination format is configured to enable predictive optimizations on the execution and management of individual advertisements, groups of advertisements, and entire advertising campaigns.

Conventional systems attempt to provide for portability of advertising campaigns between providers. These systems provide for moving advertisements, however, conventional systems typically fail to integrate historical data into any new functionality provided, among other issues. Accordingly, various embodiments of the ingestion subsystem are configured to translate historical data into a format usable by a destination management system. In some embodiments, after porting advertising campaigns by the ingestion subsystem, the new management system can operate on historical data to predict performance and/or optimize execution of advertisements. After the ingestion subsystem has translated an advertising campaign, the destination management system can then enable any level of service. For example, the destination management system can incorporate, or not, historical data into performance predictions, determinations of bid value, automated bidding control, shutting down advertisements, creating new advertisements, etc. According to one embodiment, user roles are defined and the destination management system to provide varying levels of automated assistance and analysis information. In some embodiments, regardless of the service level being employed, the ingestion subsystem captures and associates any historical information made available by the first service provider with the destination management system format, so that all the historic information is later useable

According to one embodiment, the ingestion subsystem is specially configured to capture advertisement data (e.g., existing ads, performance values, historic information, any management rules, etc.) for a service provider having a first format for data organization. In some embodiments, the first format can be pre-defined and the ingestion subsystem can translate or associate the first formation to a destination format for advertising data. In one example, the system is specially configured to capture information from the known FACEBOOK platform. The ingestion subsystem is configured to translate and/or associate any available advertising information into the destination format, and store any of the translated and/or associated advertisements and/or historical information on a destination advertisement management system. In further embodiments, how the historic information is employed by the destination advertisement management system depends on an assigned user role and service level.

According to one aspect a system for ingesting data structures in a first format to a destination format is provided. The system comprises at least one processor operatively connected to a memory, the at least one processor when executing, is configured to identify an existing account at a first service provider, the existing account associated with a first data structure format, capture authentication information for accessing the first service providers, use the authentication information, accessing advertising data stored in the first data format and map the advertising data to a destination data forma, generate performance information responsive to mapping historical advertising data in the destination data format, automatically create corresponding placements associated with the historical advertising data and execution parameters for respective placements (e.g., bid rules, stop conditions, start conditions, valuation parameters, etc.), and manage, automatically, the respective placements with the ingestion subsystem, wherein managing the respective placements includes an act of communicating by the at least one processor operation instructions to the first service provider that trigger the first service provider system to control (e.g., increase bid value, decrease bid value, stop the placement, start the placement, modify the appearance of the placement, etc.) the placement on the first provider system.

According to one embodiment, the system is further configured to enable dynamic generation of performance information responsive to user selection of data dimension (e.g., data fields, data descriptors, metadata fields, etc.). According to one embodiment, the system is further configured to generate performance information on multi-dimensional groupings of the advertising data. According to one embodiment, the system further comprises a user interface (“UI”) component configured to display high volume data analytics. According to one embodiment, the UI component is further configured to receive historical advertising metrics, analyze and group the historical advertising metrics into an advertising demographic hierarchy (e.g., advertising location, advertising target, advertising type, age group, budget pool, strategy group, ad set, individual placement, gender, custom audience, relationship, among others) configured for display in a selectable visual interface. According to one embodiment, the UI component is further configured to dynamically generate visual displays on the historical advertising metrics responsive to user selection of information dimensions (e.g., descriptive information for the advertisements or information associated with the advertisements) associated with one or more advertisements in the selectable visual interface. According to one embodiment, the UI component is configured to display information dimensions associated with advertisements in a selectable pivot table display. According to one embodiment, UI component is further configured to receive current advertising metrics, analyze and group the current advertising metrics into an advertising demographic hierarchy (e.g., advertising location, advertising target, advertising type, age group, budget pool, strategy group, ad set, individual placement, gender, custom audience, relationship, among others) configured for display in a selectable visual interface.

According to one embodiment, the UI component is further configured to dynamically generate visual displays on the historical advertising metrics responsive to user selection of information dimensions (e.g., descriptive information for the advertisements or information associated with the advertisements) associated with one or more advertisements. According to one embodiment, the UI component is further configured to dynamically generate visual displays on historical advertising metrics imported from outside providers in conjunction with current advertising metrics on advertisements managed by a destination system. According to one embodiment, the UI component is further configured to dynamically generate the visual displays of historic and current advertising metrics responsive to user selection of information dimensions (e.g., descriptive information for the advertisements or information associated with the advertisements) associated with one or more advertisements. According to one embodiment, the UI component is further configured to display summary information for the advertising metrics in each level of an advertising demographic hierarchy (e.g., advertising location, advertising target, advertising type, age group, budget pool, strategy group, ad set, individual placement, gender, custom audience, relationship, among others).

According to one embodiment, the UI component is further configure to generate a navigable user interface display including at least one selectable drawer associated with a hierarchical group of advertising metrics (e.g., site, budget pool, strategy group, ad set, placement, among other options), wherein the at least one selectable drawer includes a display of a title of a respective hierarchical group; and wherein the at least one selectable drawer is associated with a respective summary view of the advertising metrics within the hierarchical group. According to one embodiment, at least one processor is further configured to: access the advertising data via an advertising API associated with a social networking provider (e.g., FACEBOOK, TWITTER, PINTEREST, etc.).

According to one aspect a method for ingesting data structures in a first format to a destination format is provided. The method comprises identifying, by at least one processor, an existing account at a first service provider, the existing account associated with a first data structure format, capturing, by the at least one processor, authentication information for accessing the first service providers, using, by the at least one processor, the authentication information, accessing, by the at least one processor, advertising data stored in the first data format and mapping the advertising data to a destination data format, generating, by the at least one processor, performance information responsive to mapping historical advertising data in the destination data format.

According to one embodiment, the method includes dynamically generating performance information responsive to user selection of data dimension (e.g., data fields, data descriptors, metadata fields, etc.). According to one embodiment, the act of generating includes an act of generating performance information on multi-dimensional groupings of the advertising data. According to one embodiment, the method further comprises accessing the advertising data via an advertising API associated with a social networking provider (e.g., FACEBOOK, TWITTER, PINTEREST, etc.). According to one embodiment, the method further comprises displaying high volume data analytics via a user interface component. According to one embodiment, the method further comprises configuring the UI component to receive historical advertising metrics, analyzing and grouping the historical advertising metrics into an advertising demographic hierarchy (e.g., advertising location, advertising target, advertising type, age group, budget pool, strategy group, ad set, individual placement, gender, custom audience, relationship, among others) configured for display in a selectable visual interface.

According to one aspect, a system for generating build templates is provide. The system comprises at least one processor operatively connected to a memory, the at least one processor when executing, is configured to: receive selection of a group of placements in a user interface; decompose the selected group of placements into components that make up the placements (e.g., creative information (e.g., images, ad copy, visualizations in the ad, etc.), context information (e.g., social media likes, comments, shares, etc.), strategy group (e.g., logical organization of advertising objects governed by goal and spend rules), budget pool, audience information, pricing, etc.); generate a build template executable by the system that when executed causes the system to create the selected group of placements, wherein the system captures any defined parameters specified by the selected group of placements and incorporates the parameters into the build template or associated element of the build template; identify elements of the build template such that responsive to combining the elements of the build template in every permutation only the selected advertisements or a subset of the selected advertisements are defined; provide interactive access to the build template through the user interface to manage and modify the selected group of advertisements or the subset of the selected advertisements based on selections in the user interface to modify the build template or build template parameters.

According to one embodiment, the at least one processor is configured to re-generate a group of advertisements corresponding to the permutations of the modified build elements responsive to generation of the build template and the build template parameters. According to one embodiment, the at least one processor is configured to display the build template in the user interface, wherein responsive to selection in the user interface, the build template and build template parameters are accepted, modified, delete, or updated with additional elements or parameters.

According to one embodiment, the system is further configured to: identify elements of a first build template such that responsive to combining the elements of the build template in every permutation only a first subset of the selected advertisements are defined;

identify elements of at least a second build template such that responsive to combining the elements of the second build template in every permutation only a second subset independent of the first subset of the selected advertisements are defined. According to one embodiment, the system is configured to identify elements of additional build templates until each advertisement in the selected group is represented by a respective build template.

According to one embodiment, he system is configured to use authentication information and access placement data stored in a first data format and map the placement data to a destination data format; automatically create corresponding placements associated with the placement data and execution parameters for respective placements; and generate one or more build templates associated with the automatically created corresponding placements.

According to one embodiment, the system is further configured to manage, automatically, the respective placements with the ingestion subsystem, wherein managing the respective placements includes an act of communicating by the at least one processor operation instructions to the first service provider that trigger the first service provider system to control the placement on the first provider system. According to one embodiment, the system is further configured to enable dynamic generation of performance information responsive to user selection of data dimensions in the user interface. According to one embodiment, the system is further configured to generate performance information on multi-dimensional groupings of the placement data responsive to selection in the user interface.

According to one embodiment, the system further comprises a user interface (“UI”) component configured to display high volume data analytics. According to one embodiment, the UI component is further configured to: receive historical placement metrics; analyze and group the historical placement metrics into an placement demographic hierarchy configured for display in a selectable visual interface. According to one embodiment, the UI component is further configured to dynamically generate visual displays on the historical placement metrics responsive to user selection of information dimensions associated with one or more advertisements in the selectable visual interface. According to one embodiment, the UI component is configured to display information dimensions associated with advertisements in a selectable pivot table display. According to one embodiment, the UI component is further configured to: receive current placement metrics; analyze and group the current placement metrics into an placement demographic hierarchy configured for display in a selectable visual interface.

According to one embodiment, the UI component is further configured to dynamically generate visual displays on the historical placement metrics responsive to user selection of information dimensions associated with one or more advertisements. According to one embodiment, the UI component is further configured to dynamically generate visual displays on historical placement metrics imported from outside providers in conjunction with current placement metrics on advertisements managed by a destination system. According to one embodiment, the UI component is further configured to dynamically generate the visual displays of historic and current placement metrics responsive to user selection of information dimensions associated with one or more advertisements.

According to one embodiment, the UI component is further configured to display summary information for the placement metrics in each level of an placement demographic hierarchy. According to one embodiment, the UI component is further configure to generate a navigable user interface display including at least one selectable drawer associated with a hierarchical group of placement metrics, wherein the at least one selectable drawer includes a display of a title of a respective hierarchical group; and wherein the at least one selectable drawer is associated with a respective summary view of the placement metrics within the hierarchical group. According to one embodiment, the at least one processor is further configured to: access the placement data via an placement API associated with a social networking provider.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment in any manner consistent with at least one of the objectives, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. Various aspects, embodiments, and implementations discussed herein may include means for performing any of the recited features or functions.

### BRIEF DESCRIPTION OF THE FIGURES

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is block diagram of an example system, according to one embodiment;

FIG. 2 is block diagram of an integrated system, according to one embodiment;

FIG. 3 is block diagram of a system for generating and displaying a graphical user interface for high volume data analytics, according to one embodiment;

FIGS. 4A-4C are block diagrams illustrating various components of a system, according to one embodiment;

FIGS. 5A-5J are screenshot images showing various user interfaces, according to some embodiments;

FIG. 6 is a flow chart illustrating an example process, according to one embodiment;

FIG. 7 is a flow chart illustrating an example process, according to one embodiment;

FIG. 8 is a flow chart illustrating an example process, according to one embodiment;

FIG. 9 is a block diagram of a special purpose computer system, according to one embodiment; and

FIGS. 10-16 illustrate example screen captures of user interfaces according to some embodiments.

### DETAILED DESCRIPTION

According to one embodiment, an ingestion subsystem is configured to automate capture of advertisement information from various advertising platforms (e.g., the known FACEBOOK platform). In other embodiments, the ingestion subsystem is also configured to automate capture of advertisement information from other systems (e.g., GOOGLE, YAHOO, etc.). In further embodiments, the ingestion subsystem is also configured to process placement and/or placement information that currently exists or was created on a consistent management system. The consistent management system can include or operate in conjunction with the ingestion subsystem to reduce the complexity of managing hundreds, thousands, and even hundreds of thousands of executing placements.

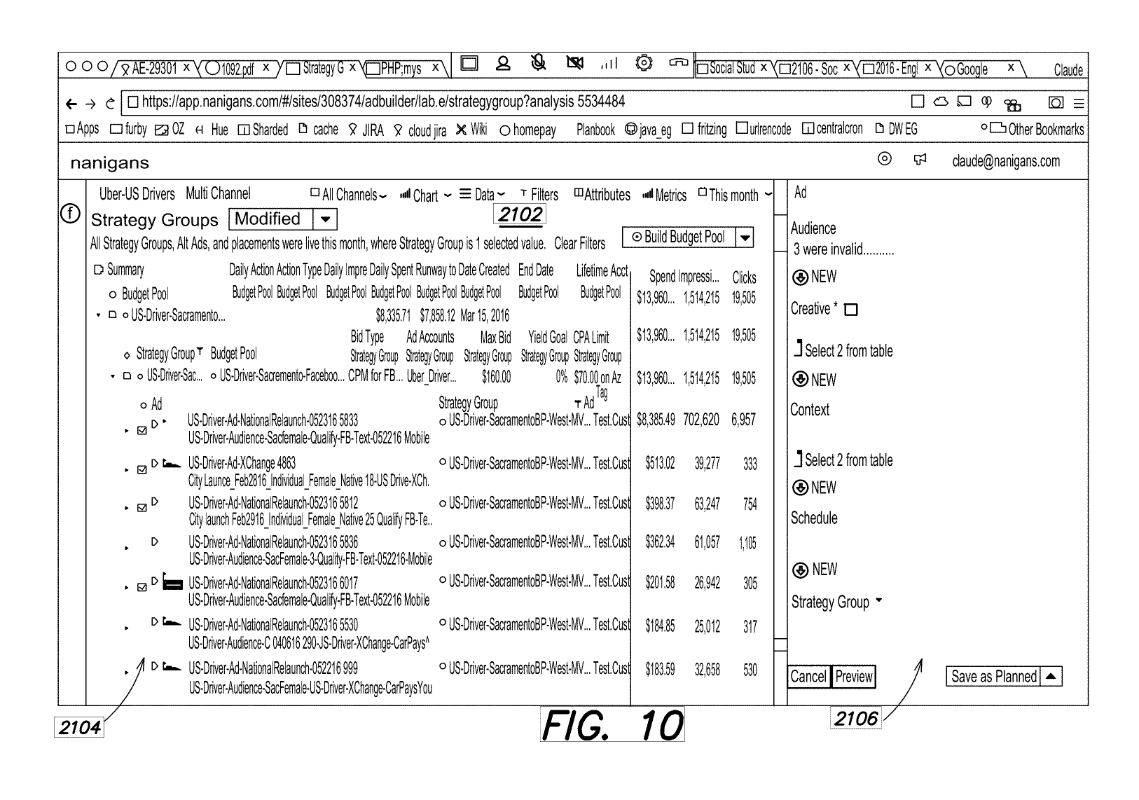

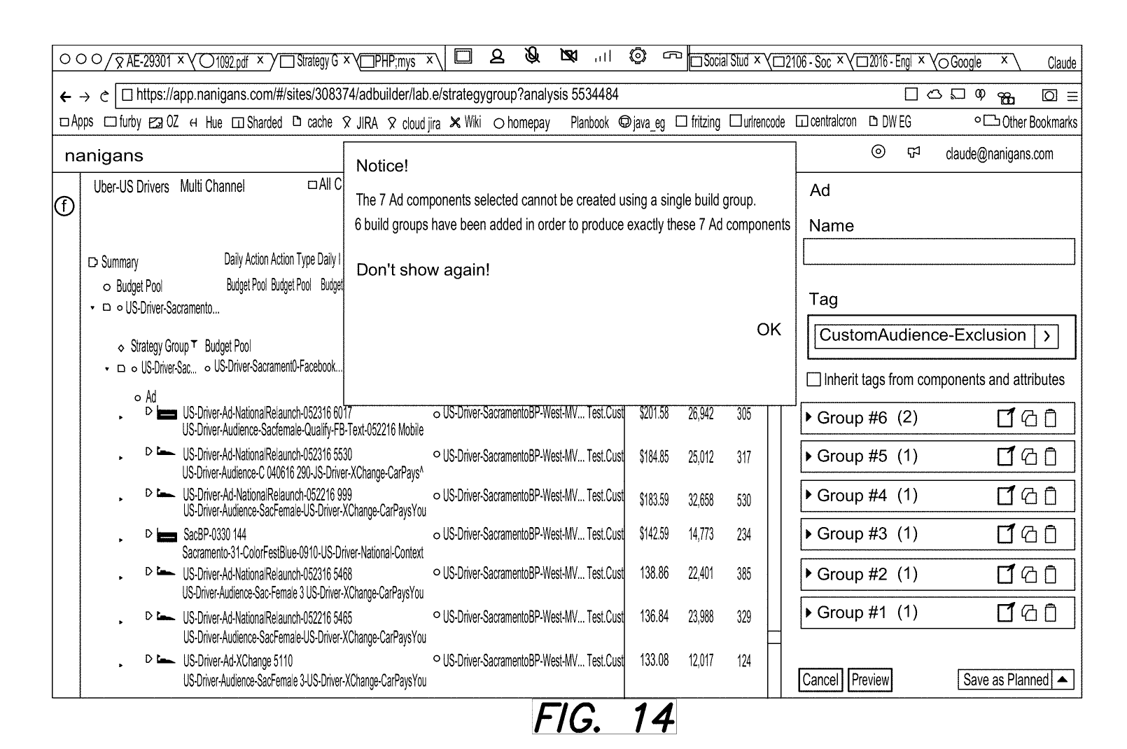

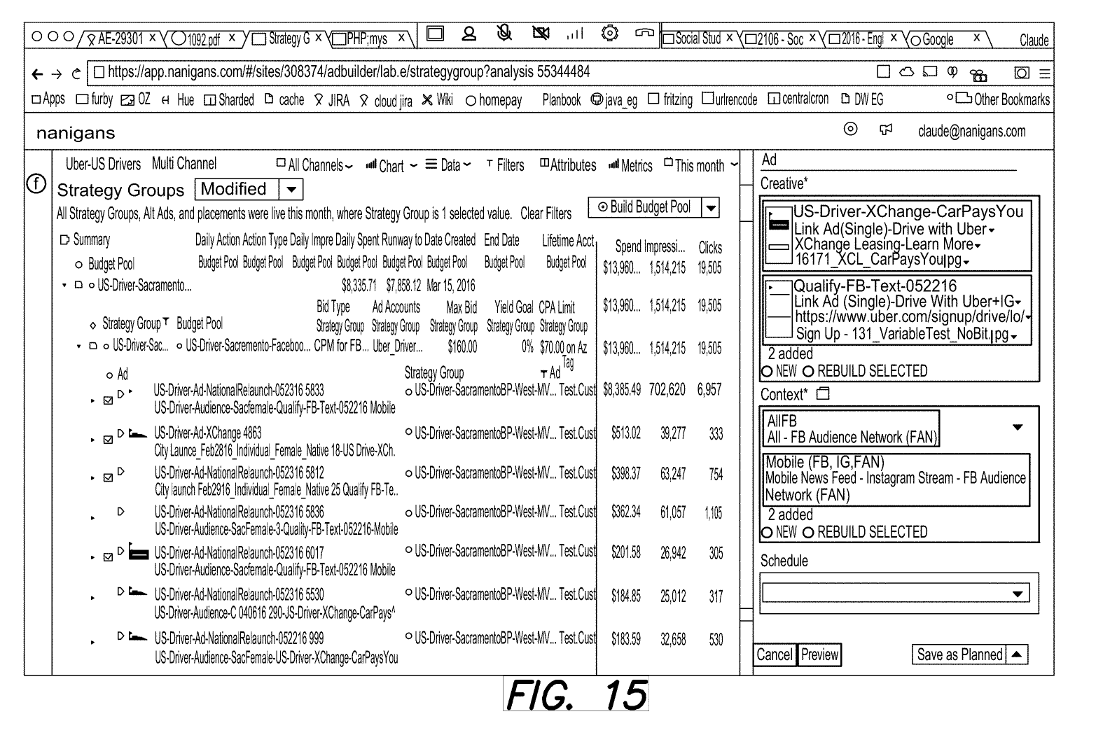

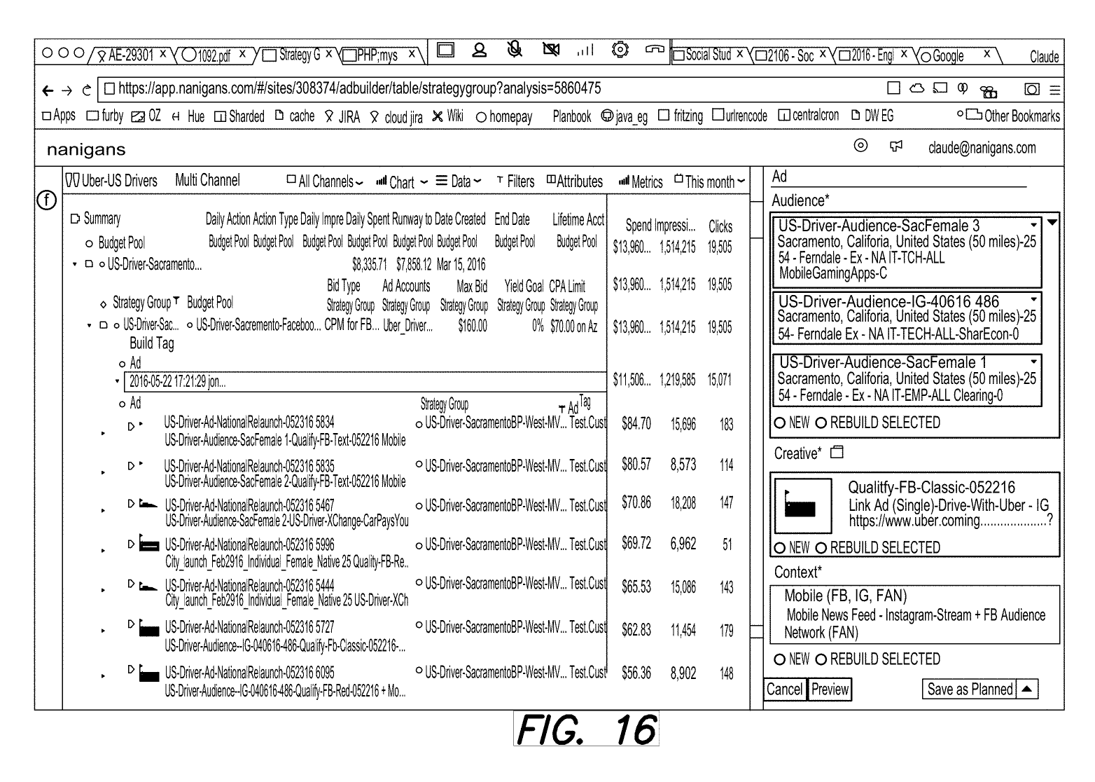

FIGS. 10-16 include example screen captures from the consistent management system. The screen captures illustrate functions provided on the consistent management system to create build templates for grouping and/or managing multitudes of placements. In some embodiments, execution of the user interface displays causes the system to access the ingestion subsystem and/or to trigger the functions associated with generating build templates for controlling groups of placements. For example, FIG. 10 shows a management window displaying placements organized under a strategy group at 2102. At 2104, users can select specific ads to rebuild. Rebuild execution for the consistent management system can include generating build templates that allow the system to re-create the selected placements. In various embodiments, the system is configured to generate one or more build templates that can be executed by the system to create those selected placements (and only those selected placements).

According to one embodiment, the consistent management system is configured to execute build templates to create all possible combinations of placement components. Thus, in order to create only the selected placements, the system must create minimal build templates that are associated only with the selected ads and respective components. In further embodiments, the system is configured to identify minimal build templates for groups of placement components, and also to identify when multiple build templates are required to match on only the selected placements and respective components. In one implementation, the system identifies all of the placement components that make up the selected ads. Then the system generates tree based data structures connecting the components, in response to adding a component that results in additional placements (beyond those selected) or identifying a component that cannot be added to the tree structure, the system creates an additional tree representing that component and structure. The analysis is repeated until each component is represented on a tree and each tree structure becomes a build template once all of the components have been added to the trees.

Other approaches for identifying minimal build groups can be implemented, including search based executions for finding minimal clusters to represent the advertising components as well as implementing graph based data structures and analysis for minimal build groups.

Once the build templates have been created, the group of placements associated with the template can now be managed and/or modified by making changes directly to the template. According to one embodiment, the system is configured to enable modifications to the placements associated with the build group based on modifications made to the build template parameters (e.g., creative parameters, audience parameters, context parameters, schedule parameters, strategy group parameters, etc.).

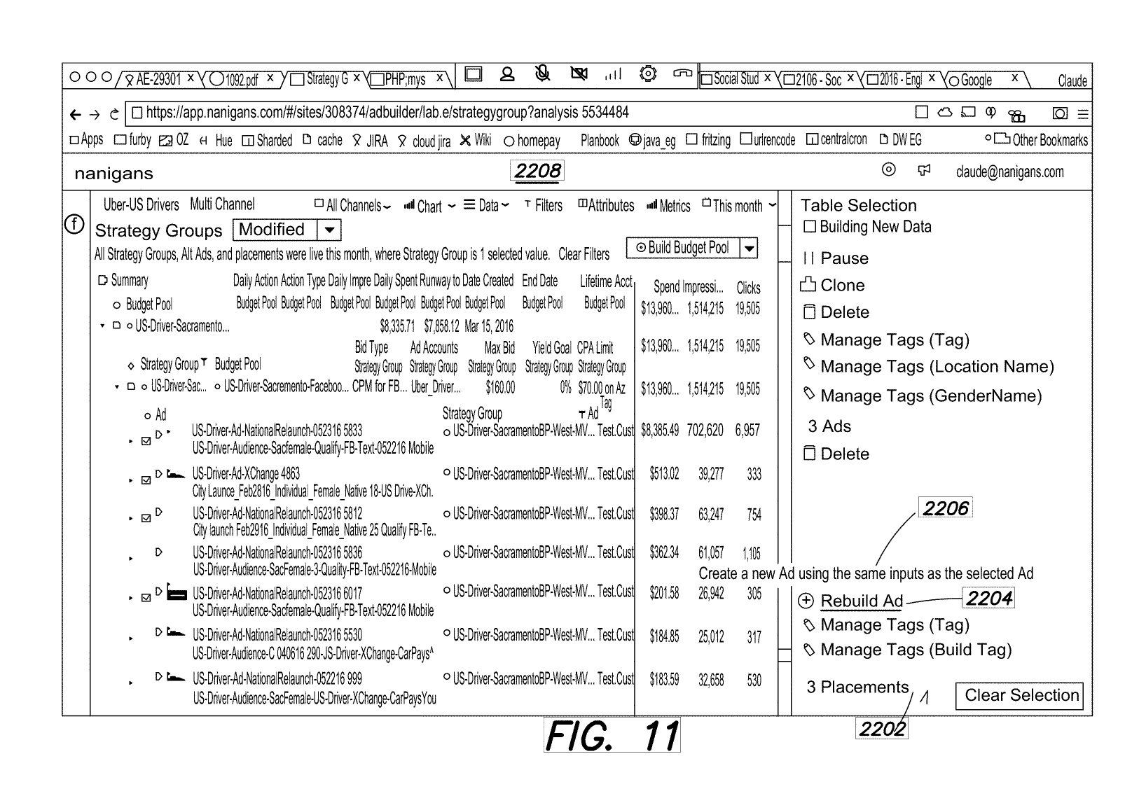

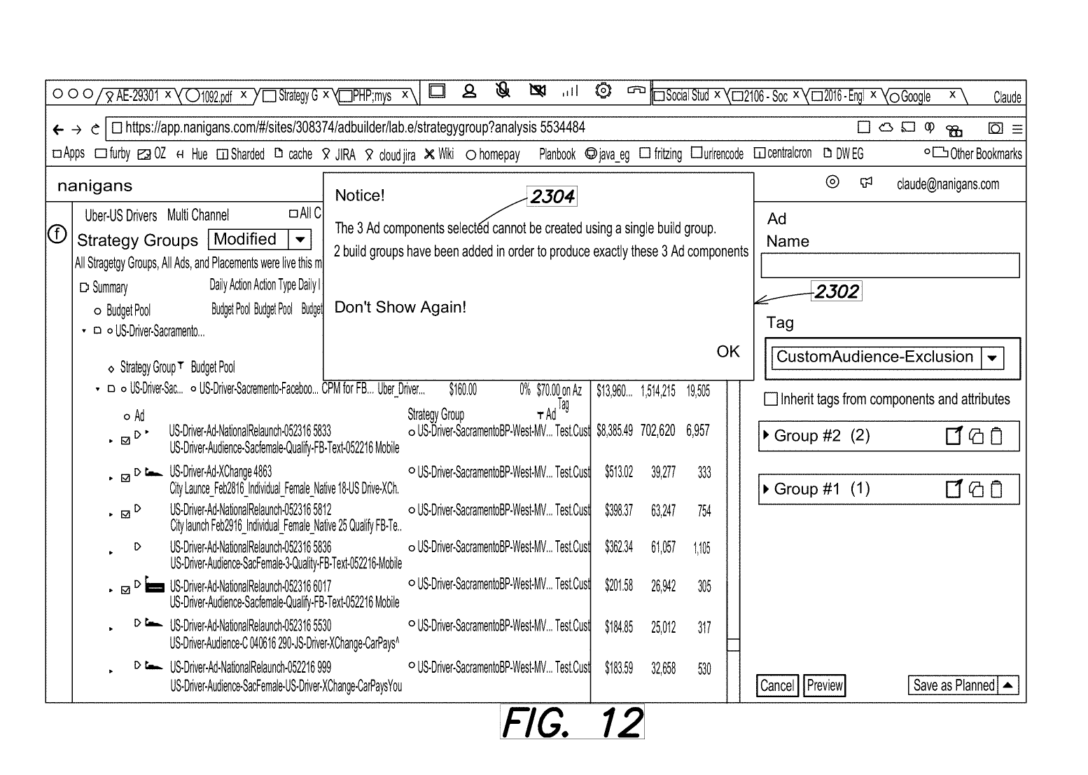

Returning to FIG. 10, shown at 2106, is a management display that can be visualized responsive to user selection. In FIG. 11, various management functions can be accessed through the management function display. For example, at 2202 users can access “rebuild” functions to enable template based control of members of the groups. At 2204, a user can select rebuild to trigger generation of a build template. In some embodiments, the system can be configured to determine if any existing build template references any of the selected ads, and use the existing build template(s) to determine if additional build groups are required. According to some embodiments, the user interface is configured to explain the functions associated with the “Rebuild Ad” available for selection at 2204. For example, responsive to hovering over 2202, the user interface displays the message “create a new ad using the same inputs as the selected Ad”—where the inputs are any existing advertising components that make up the ads selected in the left half of the UI (e.g., at 2208). As discussed above, the system is configured to identify a minimal number of build templates required to produce exactly the ads selected in the UI. As the process of determining the minimal number of build templates required is executed, the system is configured to notify the end user of the results of the template analysis. For example, shown in FIG. 12 is a screen capture of an overlay notice window 2302 and informational notice message. The message at 2304 is configured to convey the number of build templates requirements to produce the selected placements/ad components.

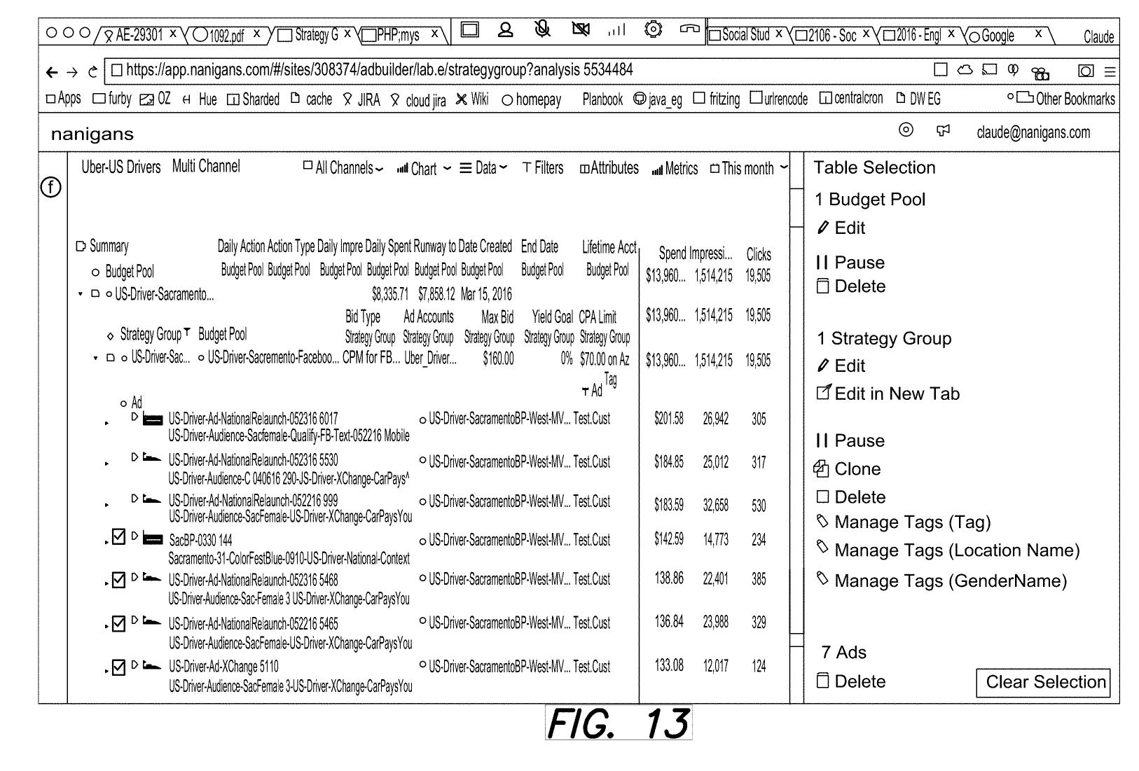

FIGS. 13-17 illustrate additional examples of selections of individual placements and display of rebuild operations performed on the seven selected placements.

According to one embodiment, the consistent management system can execute a variety of algorithms to generate a set of placement components that when combined in every iteration generate only the placements (or a subset of the placements specified). An example pseudo-code execution can include:

```
{
  Find_min( );
  { decompose_components [ui_select.placement] //read in placements selected in UI
    reached endfile = true end
    else
```

| | |
|---|---|
| parse components | // capture specification of any of audience, creative, |
| | // context, schedule strategy group or any placement |
| | // parameter |

store_component at component.list

| | |
|---|---|
| test build (component.list) | // for each new component test all |
| | // permutations of components and resulting |
| | // placements |

```
      Test proper_subset of select.placements // new tree or structure needed?
        If true continue
        Else remove component.last
          Store component.last in newcomponent.list
    end
  }
```

According to other embodiments, the system is configured to execute a recursive build process as placements selected in the UI are searched or decomposed in the placements elements that make up the selected placements. The output of the recursive build process is analyzed against the set of selected placements to determined that the output (e.g., all permutations of the placements elements) corresponds to only the placements selected or a subset of the placements. If the output includes additional placements, the system excludes the last placement element from the data structure under analysis, moves the last placement element into a separate data structure and continues until all elements have been place in the first or subsequent data structures. The elements contain in the separate data structure likewise undergo the same analysis until all the elements of the placements are classified and each data structure produces only a subset of the placements selected. Other embodiments can execute clustering algorithms to identify groups of placement elements and to identify how many clusters of placement elements are needed.

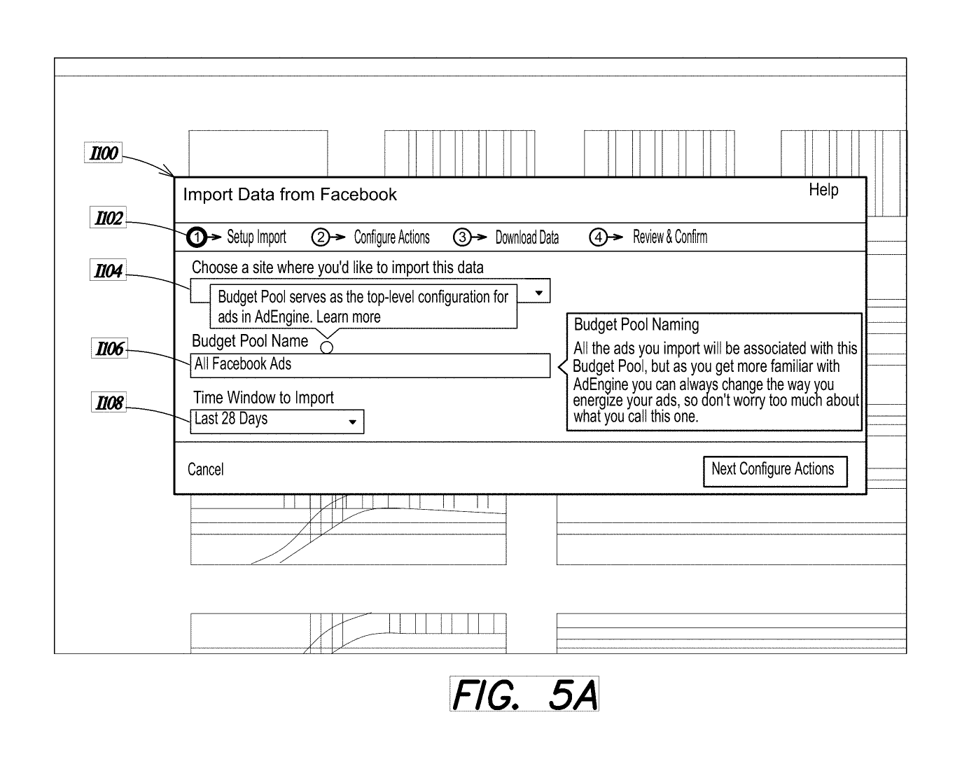

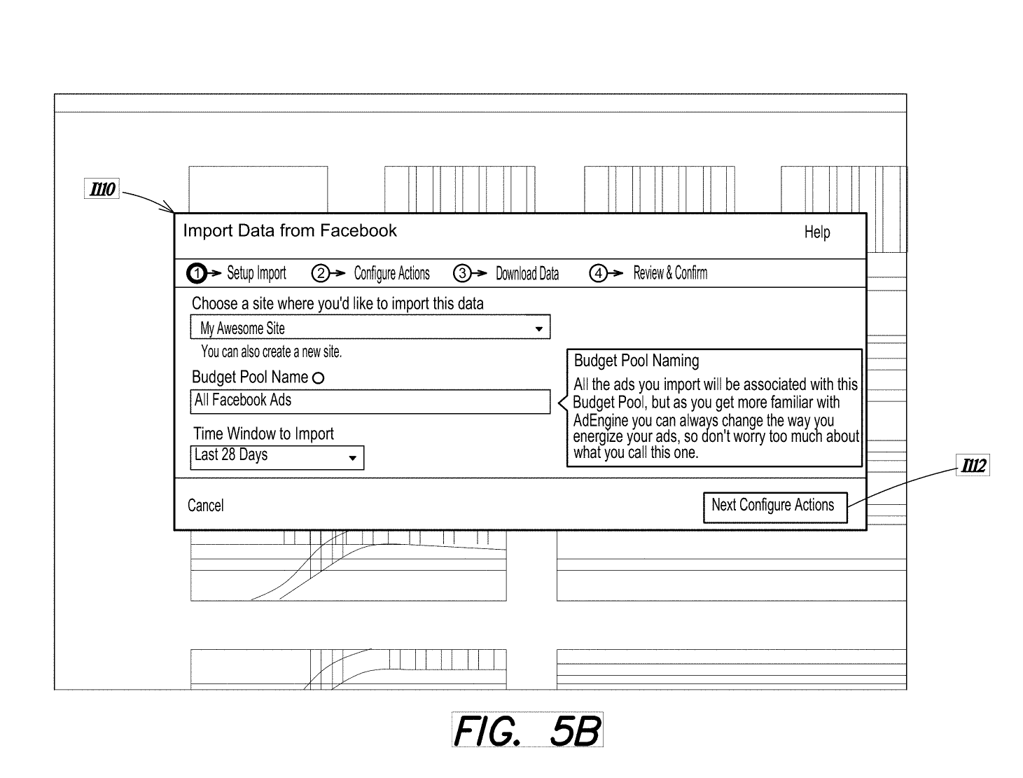

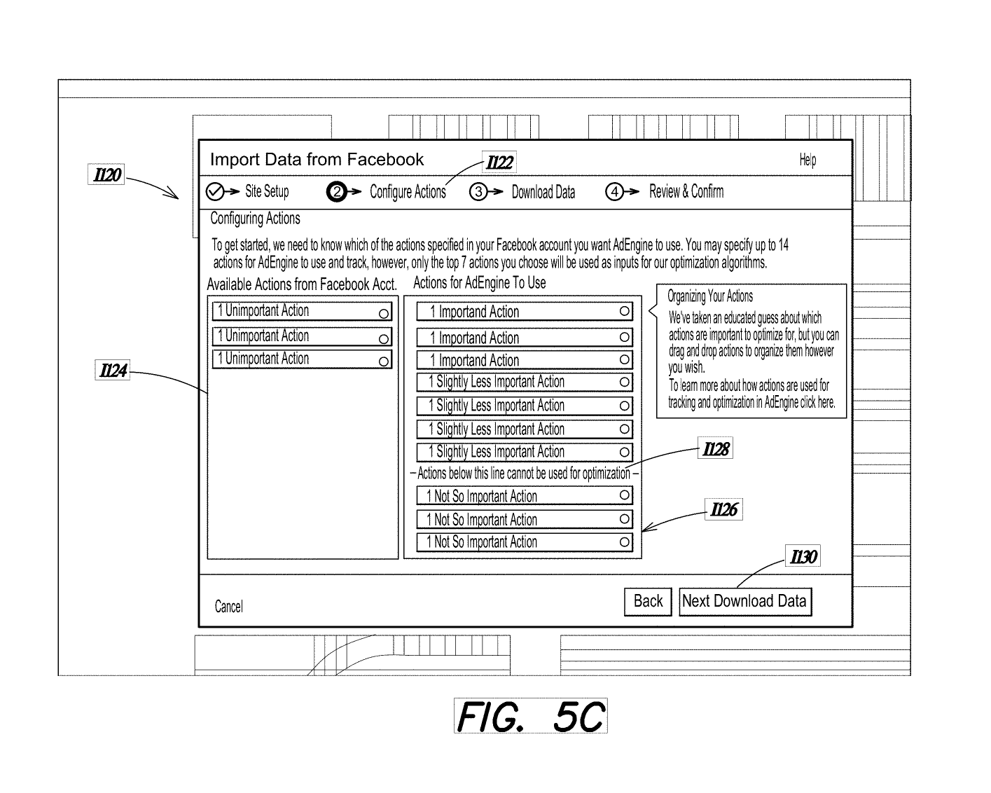

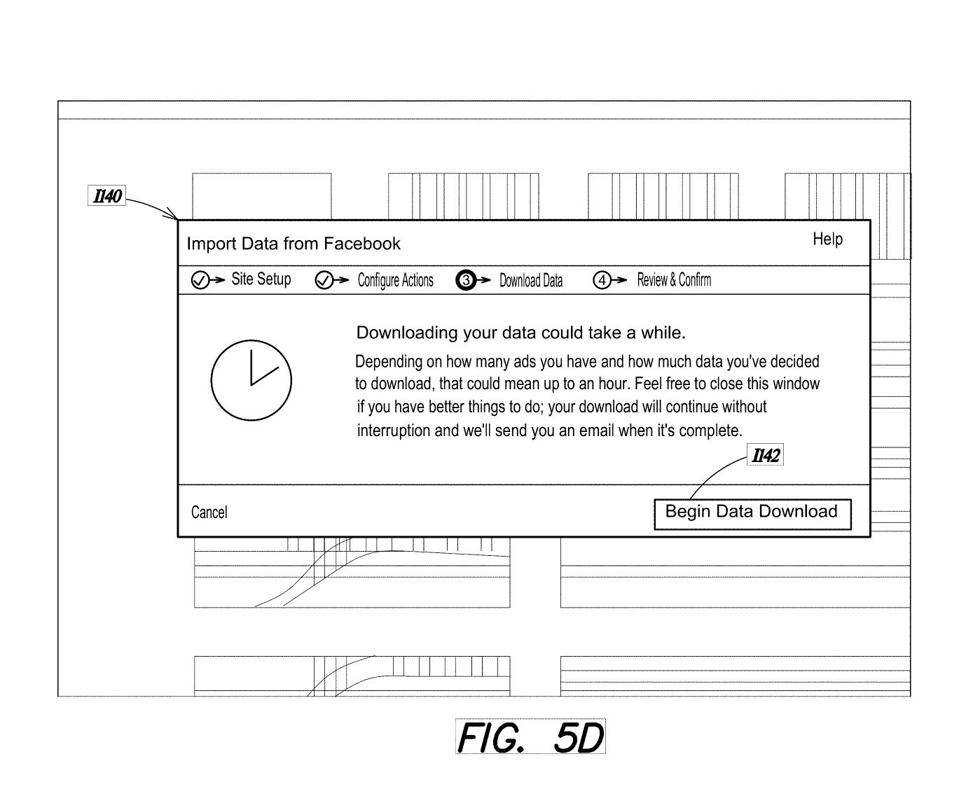

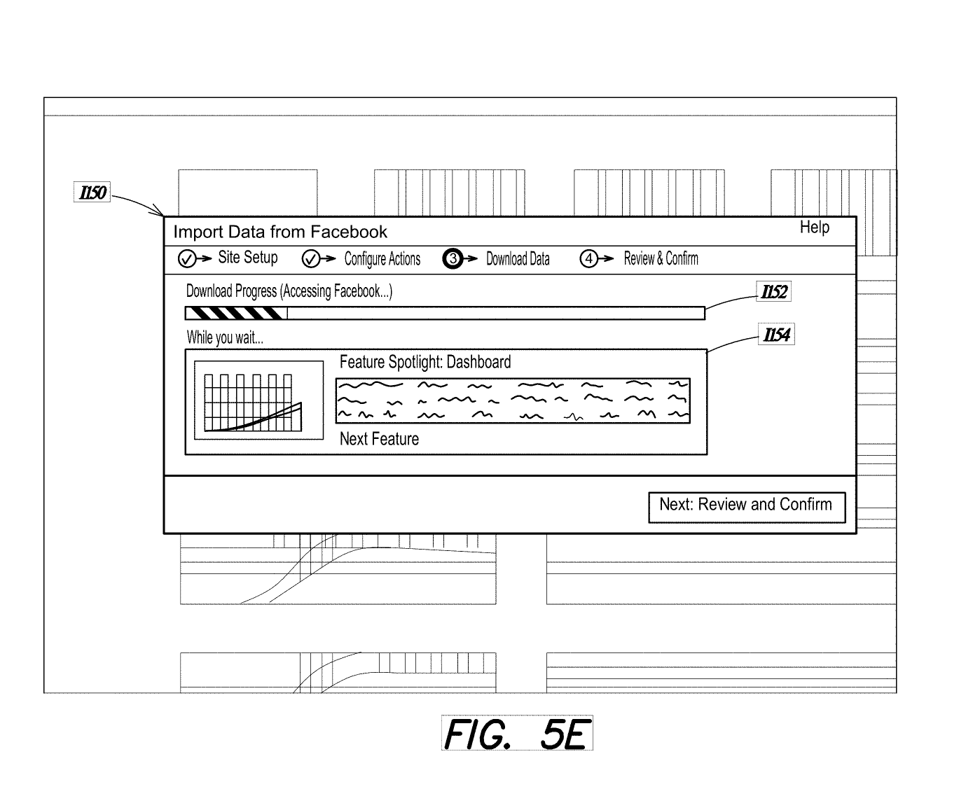

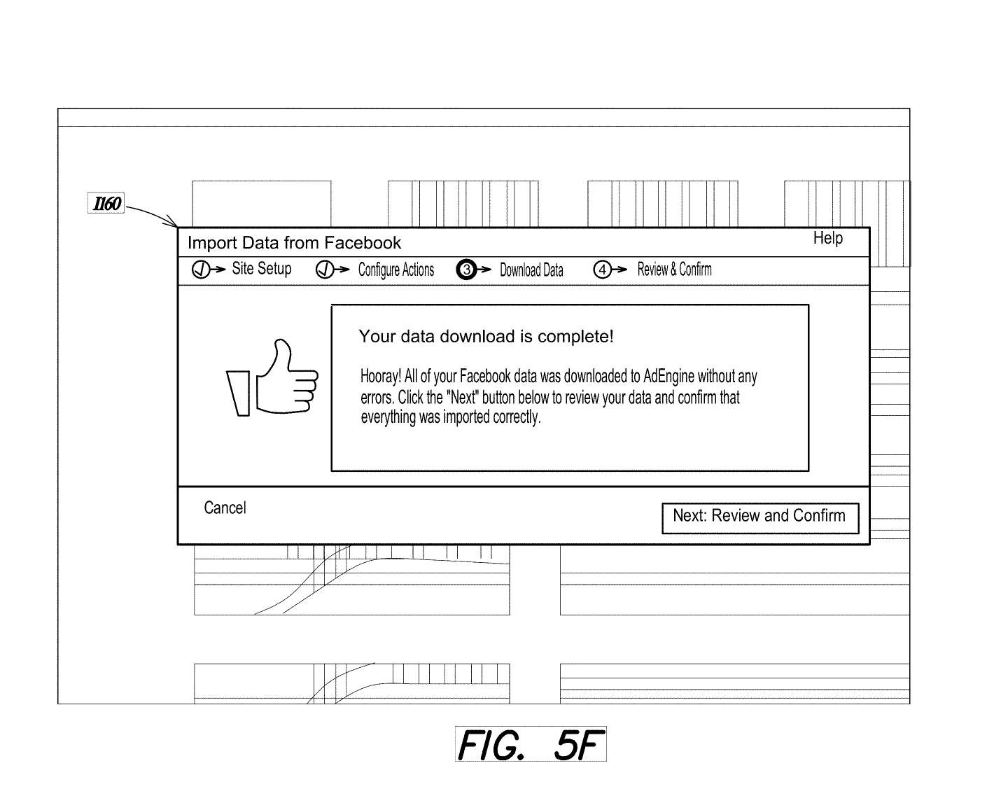

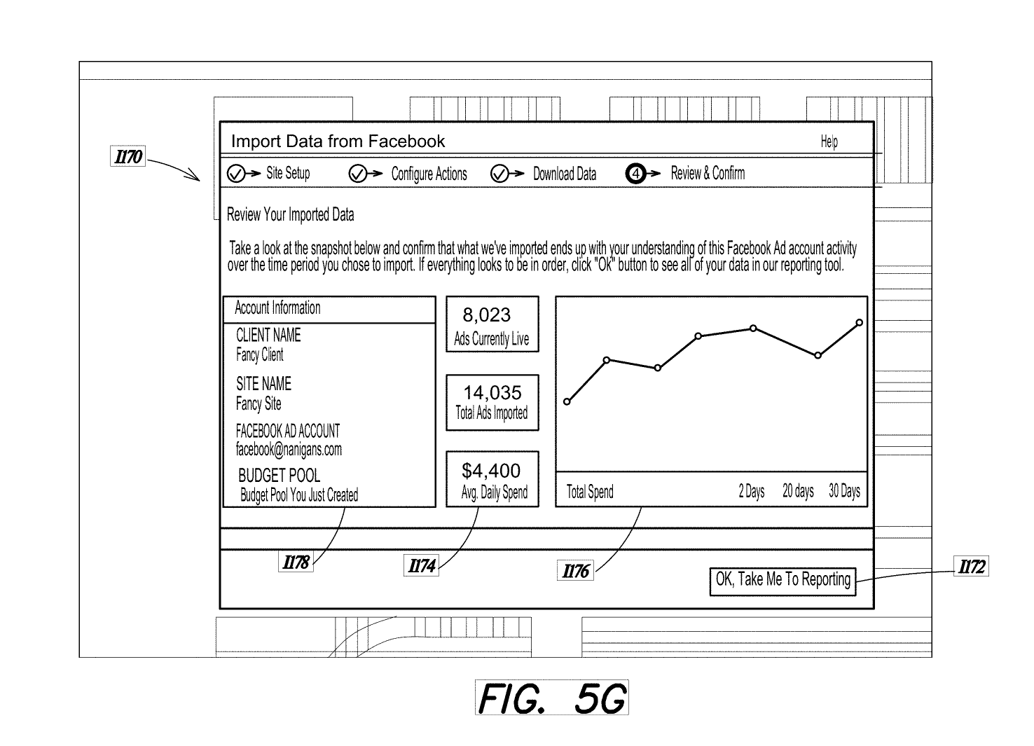

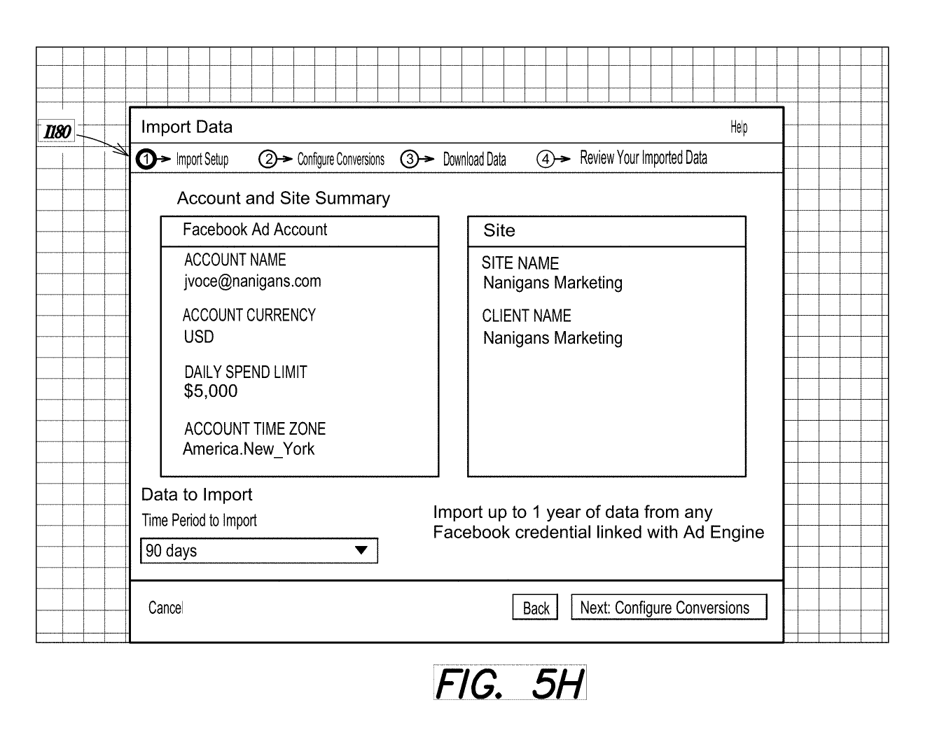

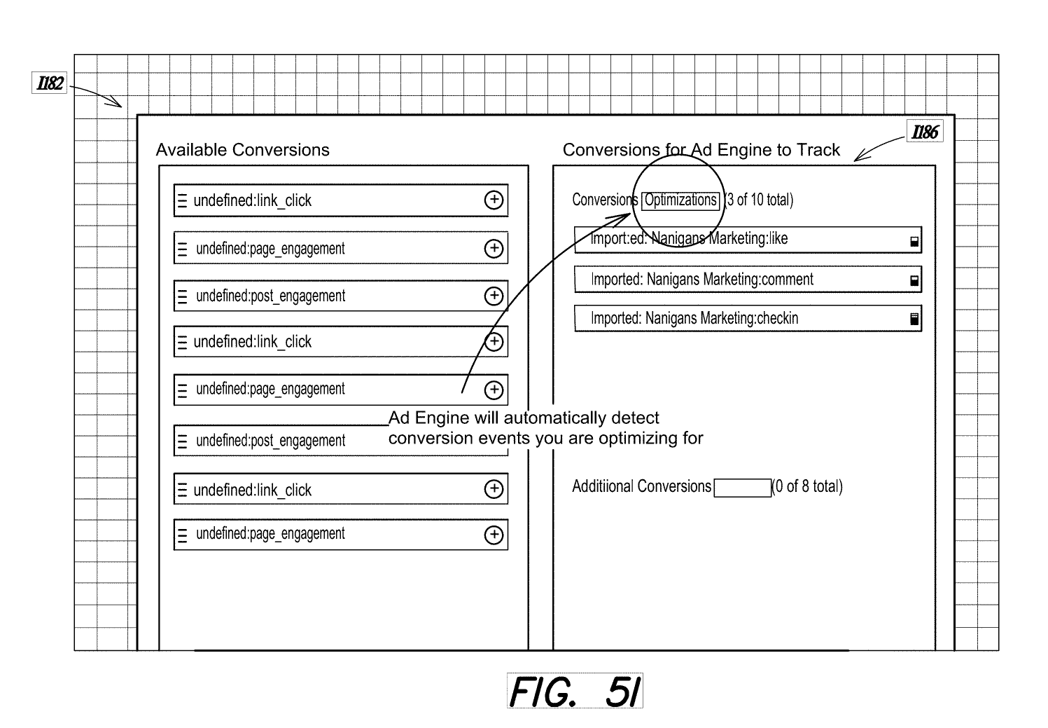

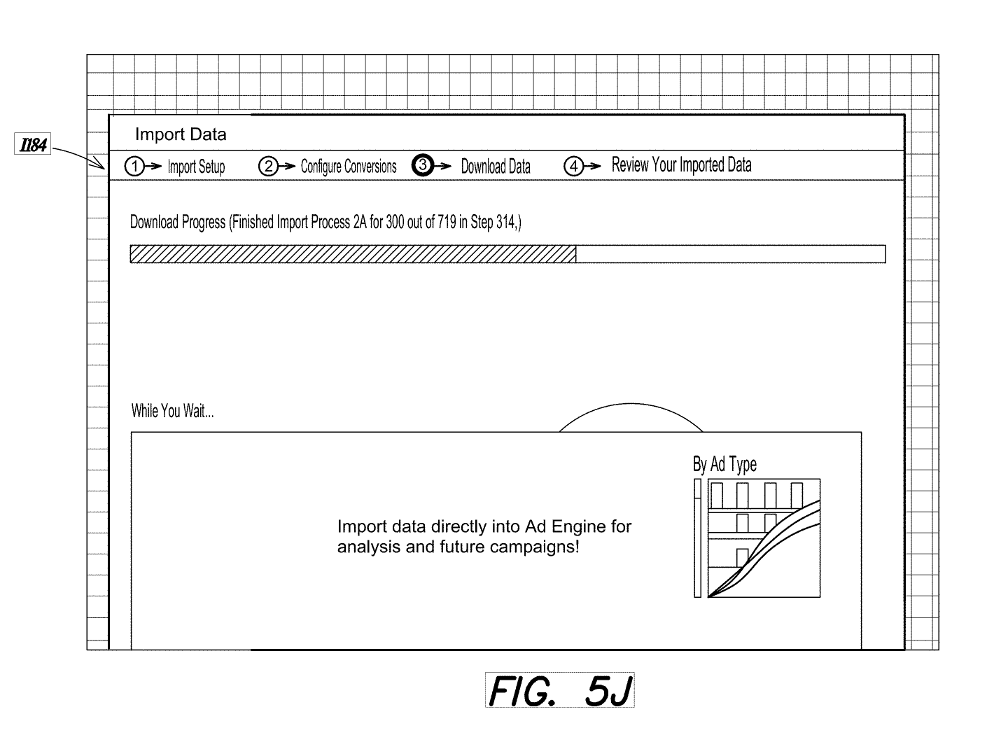

Shown in FIG. 5, is an embodiment of a user interface and user interface screens (e.g., I100) that may also be used to display ingestion information associated with external advertisements to a user. The user interface is specially configured to walk the user through the steps of automatically capturing information from an outside advertising service provider. In this example, the user interface display I100 is tailored specifically to the FACEBOOK platform. In other embodiments, additional user interfaces can be presented to the user by the ingestion subsystem to determine which outside provider has advertising data to be captured. Responsive to identification of the provider, the ingestion subsystem can use tailored user interfaces show to the user based on the identified provider.

UI I100 is configured to walk the user through a first phase of the ingestion process (e.g., Setup Import I102). At I104, the user is prompted to identify the site for which the user wishes to import the advertising data. The site specified by the user is used by the destination system to define an advertising site and associate the site with any number of advertisements, that can be further organized by budget pool. Each budget pool represents a logical organization of advertisements that can be managed together (e.g., manage advertising spent by budget pool, view revenue by budget pool, accounting by budget pool, etc.). The system can be configured to identify automatically advertisement sources that may contain budget pool information, or in further embodiments, the system can interrogate an advertising data source to determine if budget pool information may be required. If required, or searching does not identify budget pool information, at I106, the user is prompted to assign a budget pool to the information to be imported. In various embodiments, the budget pool associated for each advertisement is an editable field that the user can modify, for example, after import.

In another example, at I108, the user is prompted to specify a time window for the information to be imported. In some embodiments, the time window may be specified via a drop-down menu containing popular choices for time window input values such as “last 28 days”, or “last 7 days”, or any suitable time window value for the user's ingestion process. In FIG. 5B, user interface I110 shows the UI with user entered information. Upon selection of I112, the ingestion subsystem is configured to advance to a next phase of the ingestion process (e.g., Configure Actions, FIG. 5C, I122).

UI I120 illustrates an example display for facilitating capture and configuration of existing advertising actions from, for example, a FACEBOOK account. The UI is configured to organize actions from the service provider and the management system into sections of the display. For example, at I124 the UI displays available system actions, and applies an ordering to those actions the system determines to be of the most importance. According to one embodiment, the ingestion subsystem is configured to analyze an advertising account of another provider (e.g., a FACEBOOK account) and identify advertising actions configured on that account. For example, advertising actions can be defined based on rules. The rules can be defined with conditions and at least one action to take, responsive to the condition occurring or not occurring.

According to one embodiment, the system is configured to automatically identify system based actions (e.g., defined by programmatic language, logical execution conditions, visual based programming, etc.) to identify a condition predicate (e.g., a test condition) and a resulting operation tied to the condition predicate. The resulting operation can include complex management functions, individual actions to take with respect to a placement (e.g., pause placement, bid up placement, bid down placement, etc.), or trigger status change (e.g., alert to management, increase value, decrease value, etc.). In some examples, the ingestion subsystem is specially configured to parse displays on an access system to identify execution logic or condition statements and match that execution logic and/or condition statements to potential operations to be performed on placements. Matching between existing operations and ingested operations can be executed based on a target platform. For example, a known platform may have a multitude of known actions. Some of the known actions may include consistent formats that can be used to reduce execution complexity during matching. Known operations can be searched first for matches before any complex matching logic or machine learning based approaches to identifying and implementing ingested actions.

In some embodiments, the ingestion subsystem list identifies service provider actions and presents an ordering of the available system actions in the UI at I126. In one embodiment, the system can be configured to organize the service provider actions into management system actions based on whether each action is important for performance. In yet other embodiments, the ingestion subsystem can apply different weightings based on defined rules or information extracted from historical performance and generate an ordering based on weighted evaluations (e.g., the system assigns the highest weight to predefined actions, the next weight value to most triggered actions, etc.)

Returning to the example UI I120, the system is configured to automatically identify the highest ranked actions and display those actions in window I126. The UI I120 specifies that the actions will be used by the destination system to optimize advertising performance and/or management. In further embodiments, the destination system can limit the number of actions that are considered in generating optimization and/or analytic information.

According to one embodiment, the ingestion subsystem is configured to capture any action in window I126, so that each action will be captured by the destination system. However, as indicated in the UI I120 (at I128—“actions below this line cannot be used for optimization”), some actions will only be made available for reporting of the action but not for use in optimizing management of the advertisement(s). Selection of I130 triggers the ingestion subsystem to transition to a next phase of the ingestion process which may include, e.g., downloading of the advertisement information (e.g., ads, rules, performance, historic performance data, etc.). FIG. 5D illustrates another example UI I140, configured to educate the user on the download phase, and provide the user an option to have execution occur in the background. Selection at I142 triggers the ingestion subsystem to start downloading. In other embodiments, the UI I140 can also include a “Begin in Background” button to trigger downloading operations that run in the background of the user's computer.

FIG. 5E shows another example UI I150. UI I150 displays an indicator showing the progress of the download operation (e.g., at I152). In some embodiments, UI I150 can also include displays configured to educate the user on use of the destination system, and/or educate the user on performance analytics that will be made available on the destination system. In one example, window I154 shows information on using analytic dashboards of the destination system, information on the available performance analytics, information on automated management of an advertising campaign, among other options.

FIG. 5F shows an example UI I160 configured to display responsive to completing capture of information from the outside advertising service provider (e.g. FACEBOOK). Once data capture (and any transformation and associations between source and destination formats) is complete, the ingestion subsystem is configured to request that the user validate the captured information.

FIG. 5G shows an example UI I170. In this example, the ingestion subsystem is configured to display summary information on the captured data and request user validation (e.g., via selection at I172). UI I170 can display information on current live ads captured, total ads imported, and average daily spending (e.g., at I174). The display information can also include account demographic information (e.g., client name, site name, source account information, and budget pool assignment—at I178). In other examples, graphical information can also be displayed to facilitate validation (e.g., at 176). FIGS. 5H, 5I, 5J show additional examples of user interfaces (e.g., I180, I182, and I184) that the ingestion subsystem can utilize to capture data from outside advertising services. At I186, the ingestion subsystem can provide information on optimization of conversion type events identified in the data to be captured. In some embodiments, the ingestion subsystem can be configured to give the highest rank to conversion type events. The conversion type events can then be used by the destination system to optimize management and performance of the imported advertisements. Generally speaking, conversion is associated with converting site visitors into paying customers. In various embodiments, the ingestion subsystem is configured to identify the conversion event(s) based on identified actions or acts that are meaningful to the user (e.g., trigger payment events based on user activity). Some examples of such meaningful conversion actions are: registering for an account on a site, viewing a product from a search listing, adding items to a “shopping cart,” installing a mobile apps or games, and reaching a certain level of completion in a game.

### Example System

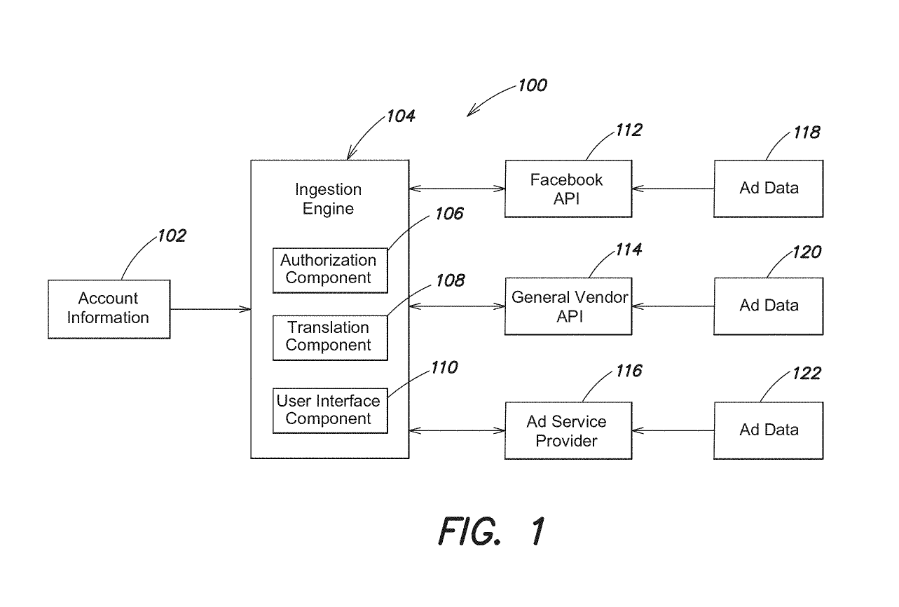

FIG. 1 shows an example of an ingestion subsystem 100 for capturing, translating and/or associating existing advertising data from an outside advertising service provider to a destination advertising management system. The system 100 can also be configured to ingest advertisements currently existing on the system 100 to tie those existing advertisements to one or more build templates for grouping and controlling the ingested advertisements. When accessing advertisements existing on the system, many of the functions associated with accessing accounts have already been performed, thus the system can be configured to execute functions associated with identifying the ads to ingest without need for further authentication.

According to one embodiment, the system is configured to receive account information 102 for an existing advertising account serviced by an outside provider. According to one embodiment, the system 100 can include an ingestion engine 104. The ingestion engine can be configured to access outside advertising providers using the account information 102 and capture advertising data (e.g., 118, 120, and 122 ) from one or more providers. In some embodiments, the ingestion subsystem is specially configured to capture information from specific providers (e.g., FACEBOOK). The system can capture advertising data through one or more application programming interfaces (APIs) (e.g., 112—FACEBOOK API, non vendor specific APIs—114, and/or capture data directly—116 (e.g., via queries, exports, direct downloads, robot crawling).

According to one embodiment, the ingestion engine 104 and/or system 100 can include components specifically configured to execute functions as part of a process of capturing advertising data from one or more advertising service providers for use in a destination advertisement system. For example, the system can include an authorization component 106 configured to use account information 102 to authorize the system to capture information from an outside service provider. In another example, the system and/or ingestion engine 104 can include a user interface component 110. The user interface component can be configured to generate user interfaces that facilitate capture of existing advertising information (e.g., as described in FIGS. 5A-5J). In other examples, the user interface component 110 can generate universal user interfaces configured to interact with multiple vendor APIs or non-vendor specific APIs to capture advertising data. The universal user interface can also be configured to facilitate capture of information from users to enable direct capture of information from an outside provider where no APIs are available.

In further embodiments, the ingestion subsystem 100 and/or ingestion engine 104 can also include a translation component 108. The translation component 108 can be configured to build associations between a first provider format for advertising data and a destination formation for advertising data. In some examples, the translation component includes information on data structures used by a first provider (e.g., FACEBOOK) and mappings to data structures used in on the destination system. The translation can then capture and fill destination formatted data structures containing all of the previous advertising information. In further embodiments, the translation component 108 enables the destination system to use the historical advertising information as if it were originally created on the destination system.

According to one embodiment, FACEBOOK is configured with a strict object hierarchy in their data model. Each advertising account contains Campaigns, which contain Ad Sets, which contain Ads. In conventional implementation targeting, budgeting, and bidding are allowed at the adset level in their data model, and further ads are unique only in creative (and may also contain override bids). By ingesting existing advertisements (e.g., into ingestion subsystem of FIG. 1), the system enables more complex data structures for the existing advertisements and enables improved algorithmic control over each element of the complex data structures. For example, the ingested campaign management model is much more flexible, where targeting, bidding, budgeting, and creative may all be set at the Placement (e.g., ad level) level for each advertisement (which maps to a Facebook Ad—as discussed is not capable of targeting, bidding, and budgeting in the FACEBOOK system), and in addition placements may be organized and manually manipulated using a variety of organizational concepts including: grouping by targeting or creative feature, generic tagging, or by automation groupings, comprising Strategy Groups and Budget Pools.

When, for example, a Facebook Ad account is imported, the data structures corresponding to the Ad account are mapped to placements (e.g., individual ad objects) that are collected (e.g., automatically organized) into an “ingestion” Budget Pool and Strategy Group, and can later be moved according to whatever campaign management strategy suits the customer. The system can automatically manage the placements via the ingestion budget pool and strategy group, and also provide user interface prompts to enable end users to move placements into different groups and pools or create new strategy groups or budget pools. The system is configured to automatically manage any level of the end mapping organization structures holding the placements. In one embodiment, the ingestion subsystem maps each of the data structure elements from the FACEBOOK data models into the placement hierarchy of the ingestion subsystem via table based mappings.

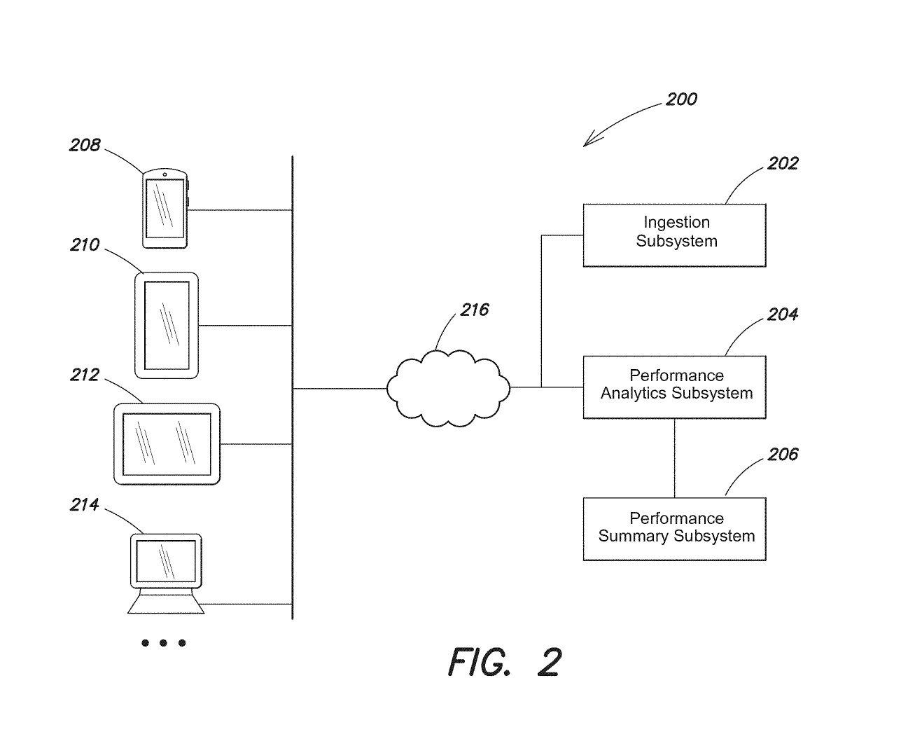

FIG. 2 is a block diagram of an integrated system including an ingestion subsystem 202 coupled to a performance analytic subsystem 204, which may include a performance summary subsystem 206 (e.g., as described U.S. patent application Ser. Nos. 15/166,815 and 15/166,827, entitled “GRAPHICAL USER INTERFACE FOR HIGH VOLUME DATA ANALYTICS,” filed on May 27, 2016, in U.S. patent application Ser. No. 15/166,852, entitled “SYSTEM FOR HIGH VOLUME DATA ANALYTIC INTEGRATION AND CHANNEL-INDEPENDENT ADVERTISEMENT GENERATION,” filed on May 27, 2016, Provisional Patent Application 62/168,303 filed on May 29, 2015 incorporated by reference herein in their entirety). Any number of users can access the integrated system 200 using any number of computing devices (e.g., 208-214—mobile devices, laptops, desktops, tablets, smart phones, etc.). The users can connect to the integrated system over network 216, which can include any of the following elements or any combination of the following elements: local area networks, wide area networks, private networks, virtual networks, and which can include or comprise the Internet.

According to various embodiments, the ingestion subsystem 100 or subsystem 202 can be configured to execute a variety of functions to capture existing advertisement information.

An example process flow for capturing information from an outside advertising provider is described below. In one embodiment, the ingestion subsystem 100 or subsystem 202 can be specially programmed to execute the example process flow. In other alternatives the integrated system 200 can executed the example process flow. Other embodiments can execute different process flow and can execute different process flows based on the outside provider.

### Example Embodiments

In one embodiment, users select functions for FACEBOOK Ad Account Import. The functions enable ingestion of ads, ad campaigns (groupings of ads), creative assets or “creatives”, and more from Power Editor, Ads Manager, or even another preferred marketing developer (“PMD”) (for example as long the assets were on the Open Graph—Open Graph is a protocol that enables web pages to become a rich data object in a social graph. For FACEBOOK, Open Graph enables any web page to have the same functionality as other objects on the FACEBOOK platform). Power Editor, Ads Manager, or PMD are advertising management systems, and their respective information can be ported via the ingestion subsystem in the destination format.

Once the advertising data is imported into the destination format, the destination system (e.g., 204, FIG. 2) can implement performance analysis to analyze and compare campaign performance by filtering, sorting, and pivoting on the campaign metrics and details as if those ads, campaigns, etc., were originally created on the destination system. In some embodiments, new performance analysis data structures and information are made available once the historic advertising information is imported and/or translated. For example, new data and attributes can include:
Strategy Group CPA Limit—The CPA goal associated with a Strategy Group using CPA bidding
Strategy Group Max Bid—The maximum bid value over the course of the campaign
Strategy Group Yield Goal—The target goal set up within the Strategy Group
Budget Pool Lifetime Budget—The amount of lifetime spend allocated for a Budget Pool

According to one embodiment, these new attributes enable additional insight and algorithmic over strategy control groups and budget pools that are not available in other advertising systems (e.g., FACEBOOK). Other additional features include interactive displays for creative group dialog box—users can view more content within the creative group organizational units within advertising networks and/or budget pools. The dialogue boxes include drop down selection of data and metrics allowing users to pivot information displays dynamically.

Aspects of the present disclosure relate to some benefits of some embodiments, and implementation associated with ingesting advertisements from the known FACEBOOK platform. The following examples include various steps implemented in some embodiments for ingesting data from FACEBOOK accounts. The following embodiments and example process flows describe user scenarios, data flows, and integration with publically available FACEBOOK APIs that enable processing and downloading of the advertisement data made available on the FACEBOOK platform. Different embodiments can provide different flows, and interactions with other service providers can also require integration with other APIs. However, the following example flows are used to illustrate aspects of the invention and the invention should not be limited to the following examples.

In a first example flow, a process to ingest and sync FACEBOOK Ad account data into Nanigans Ad Engine is described. In this example, FACEBOOK Ad Account ingestion will download existing ads running in Power Editor into Ad Engine for consolidation, analysis, and more. Some of the benefits customers may receive from utilizing FACEBOOK Ad Account ingestion are:
Consolidate FACEBOOK Ad Campaign Reporting: Easily view all FACEBOOK

Ad campaign information in one solution, and take advantage of Nanigans advanced Business Intelligence capabilities using Performance Analysis.
Aggregate Campaign Data for Any Attribute/Metric: Utilize any of the 80+ reporting attributes available within Performance Analysis to drill-down into campaign and ad performance using an excel like pivot table that offers speed and flexibility in your reporting. Seamlessly compare performance of different creatives with the numerous attributes available in Performance Analysis.
Utilize ROI-Driven Budgeting and Optimization: For any further ad campaigns created in Ad Engine you can take advantage of Nanigans automation algorithms for budgeting and optimization to help make the most of every ad dollar.
Automate Ad Creation; Testing, and Bidding: Using Nanigans Ad Engine you can define the elements of a campaign (image, copy, targeting, etc.) and Ad Engine will automatically build all of the available ad combinations for you. In addition, after you define your campaign goals, Ad Engine will automatically bid and budget accordingly to maximize your campaign performance.

In this example, FACEBOOK Ad Account ingestion will download existing ads that are running in Power Editor and create a new Budget Pool inside Ad Engine for all of the placement data, then automatically create Goals and Rules for each different Ad Type. All historical data can be found within performance Analysis. Any creative such as images, etc. that was used within ads will be automatically downloaded and can be used within newly created Ad Plans. Additionally, this ingestion process allows users to take current ads managed in Power Editor and manage them within Ad Engine via Goals and Rules without having to repush or make changes to the ads.

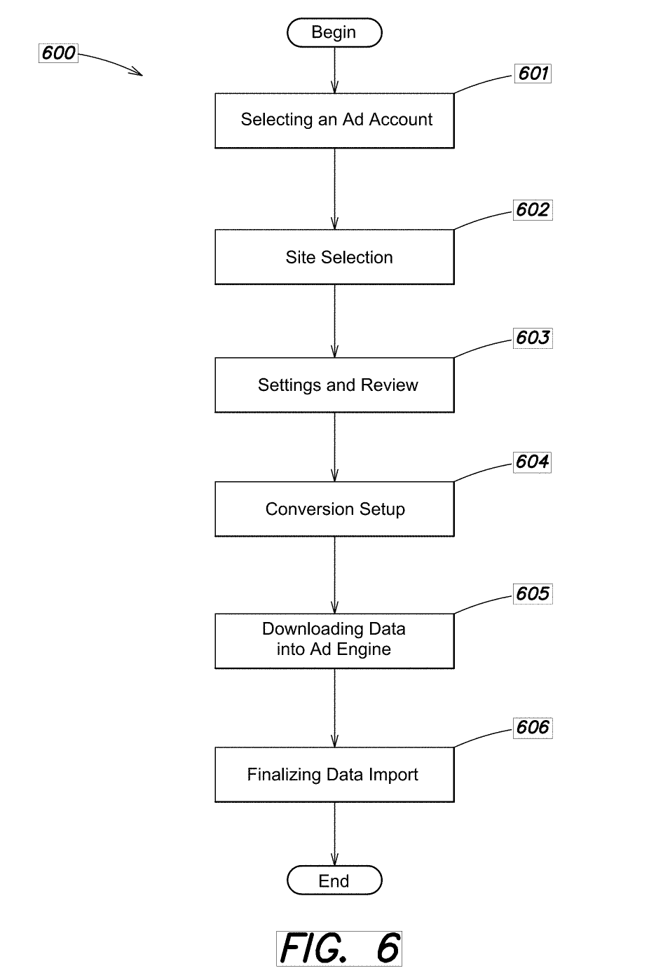

FIG. 6 is a flow chart illustrating an example FACEBOOK Ad Account ingestion process 600 as the following steps describe. Note that while in certain steps, numerical values such as the number of days, the number of accounts are given, though they are for illustrative purposes only. Any suitable numeric values may be used in an embodiment in accordance with aspects of the present disclosure.

Step 601: Selecting an Ad Account:
From the Ad Account page you will see a new option next to credentials to “Import”.
Selecting Import will kick-off a wizard to import data from your FACEBOOK Ad Account into Nanigans Ad Engine.

Step 602: Site Selection:
Select a site you would like to import data for.

Step 603: Settings and Review:
Ensure all of your FACEBOOK Ad Account and Site data is correct and select the time period for data to import.
The options for importing time periods into Ad Engine are:
   7 Days (previous 7 days from current date)
   28 Days
   90 Days
   Lifetime (includes all Power Editor data from the life of the FACEBOOK Ad Account)

Step 604: Conversion Setup:
Select and prioritize up to 7 conversion events for optimization, and 8 for reporting.
By default all conversion events are setup with 28 day click, 1 day impression attribution window. The attribution window can be adjusted in the Conversion Setup window.
Note: Ad Engine can be configured to automatically select some conversions for optimization and reporting based on site setup and FACEBOOK Account. The UI enables re-ordering and removing these conversions as necessary.

Step 605: Downloading Data into Ad Engine:
In this step data will begin to be downloaded from FACEBOOK and imported into Ad Engine. The progress bar will show you how much of the process of downloading has been completed.
Under the progress bar Ad Engine will highlight key features of the product with helpful “how to's” on how to begin utilizing each feature. You can exit this download window while in progress and the download will occur in the background. A button will appear in the top-right bar of Ad Engine next to Notifications, clicking this will recall the wizard so you can view the progress of downloading data.

Step 606: Finalizing Data Import:
Once all of your FACEBOOK Ad Account data has been downloaded the final step of the process is to Review and Confirm your data. Ad Engine will display the following data once the download has been completed:
   Ads Currently Live
   Total Ads imported
   Average Daily Spend
   Graph (will show either Spend, Impressions or Clicks for imported time period)
Once you have confirmed your data, you can view all FACEBOOK ad account information within Performance Analysis by clicking the blue “OK, Take Me To Reporting” button.

In the example of process flow above, Performance Analysis is a feature that may enable advertisers to quickly get a holistic picture of campaign performance. Featuring an advanced pivot table, Performance Analysis, enables quick visualization and dive-into deep campaign metrics and view just the data that matters to you. In addition to viewing and saving custom reports—you can directly optimize and take action within your ad campaigns from Performance Analysis.

Another feature described in the example process flow above is Automatic Ad Building. Using Nanigans Ad Engine you no longer have to manually create every ad placement. Simply define the elements of your campaign—such as image, ad copy, link, and targeting then Ad Engine will automatically build all of the possible combinations for the ad types you specify. Whether you are creating 10 ads, or 10,000 ads Ad Engine saves you time building your ads and then optimizing for your business goals.

A third feature of the Nanigans Ad Engine described in this example is Revenue Optimization. Nanigans may enable one to optimize ad campaigns using Predictive Lifetime Value™ (pLTV) for the acquisition of profitable customers that lead to immediate and long term ROI. Move beyond proxy metrics to real results using Ad Engine and our algorithms that help you minimize spend, and maximize revenue.

Scheduling is a fourth feature described in this example process. Nanigans Ad Engine offers the flexibility to schedule your ad campaign for specific hours, days, weeks, or months. Whether you want to run a campaign only during weekdays, only on weekends, or only during business hours you have the ability to run your ad campaign within Ad Engine and have the system automatically determine when it is optimal to do so.

A fifth feature, FBX Product Feeds, allows one to manually upload a spreadsheet, or specify an automated product feed and automatically create ads within FACEBOOK Exchange (FBX). Using Ad Engine and FBX you gain the benefit of dynamically resizing product images to optimize display settings for placements automatically.

A sixth feature, Reporting API, automatically pulls-in reporting data and syncs it within your internal business systems. The Nanigans reporting API enables you to automatically pull campaign data and sync it within your own internal business systems as often as you want it. Whether you want holistic campaign data or event—level information for targeting you can seamlessly get this information from the Nanigans Reporting API.

Dashboard is another feature used in this example process, where a customer may get a snapshot of performance marketing data that is important to your business such as spend, ad type, and placement location across all ad campaigns. No diving into reporting, or collecting data—the Ad Engine dashboard gives you a holistic view of all your advertising information in one place.

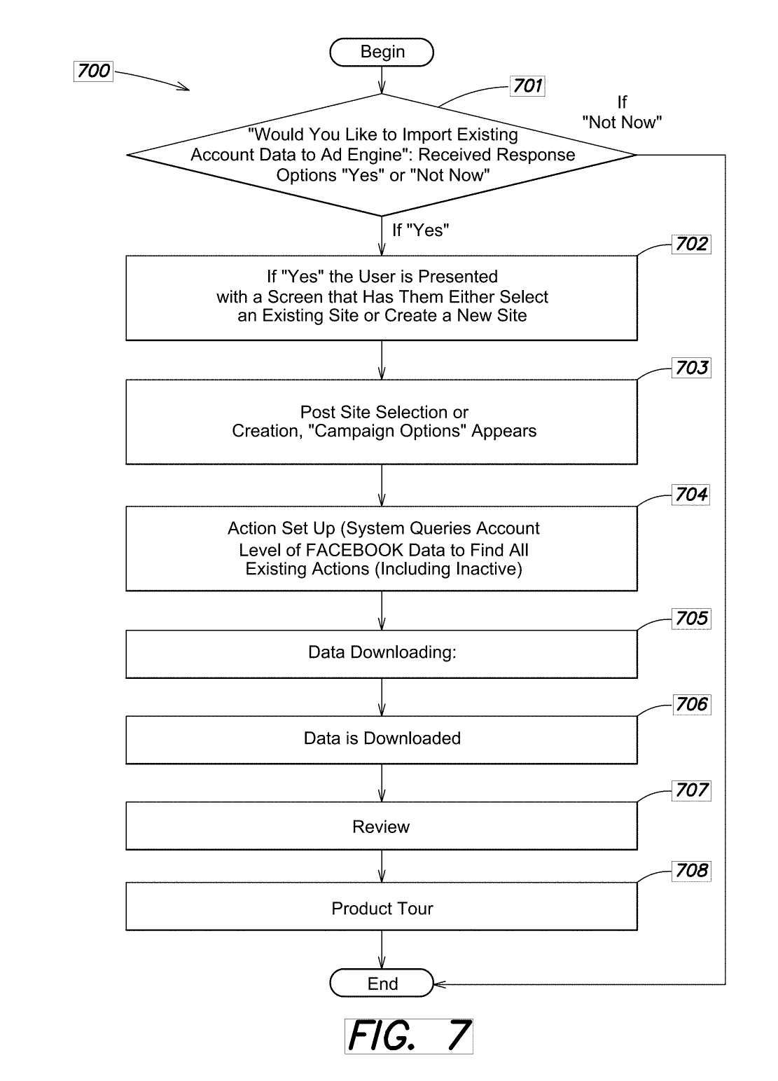

FIG. 7 is a flow chart illustrating an example setup flow 700 that includes data capture for use with full service access (i.e., complete functionality made available on historic data) and describes process elements to cover sales information and on boarding (i.e., activating) new clients. Given customers who are using FACEBOOK's advertisement management tools (e.g., Power Editor), the user of the destination advertisement management system should be able to view all the spend (i.e., all monetary outlays on advertising within a network or budget pool) side by side with PowerEditor metrics. In the alternative, the destination system should provide for tools to import those ads and/or ad information in the destination system.

The sales and onbrading process flow beings with
Step 701: Question: “Would you like to import existing account data to Ad Engine”: received response options “Yes” or “Not Now”;
   if “Not Now” exit flow; else
Step 702: If “Yes” the user is presented with a screen that has them either select an existing site or create a new site;
   new site flow includes generating a new site object under which the advertising information is organized;
Step 703: Post site selection or Creation, “Campaign Options” appears:
   a name option is display for user input or selection of the budget pool and for the template that system utilizes;
   advanced options will include a time window of data to download. Options are 7 days,14 days, 28 days, and 90 days(other embodiments enable time windows of one year or more—in one example default is 90 days);
   system displays “Go Back” option and “Continue to Next Step” option for user selection;
Step 704: Action Set Up (system queries account level of FACEBOOK data to find all existing actions (including inactive);
   a user interface screen appears for the users to order the system identified actions (ordered action are used by the system to create a light weight funnel (i.e., filter) for optimization);
   system displays “Select Actions to Track” option and present default order by sum of actions (see, e.g., FIG. 5C);
      Example of default ordering includes—largest sum of actions to smallest sum of action when presenting the list
      users can re-order the actions via drag and drop and/or trash ones they don't want to insert into tracking orders;
   in one example user has two options one for “reset” which restores any changes and “Ok, I got it. Let's move on and review everything”;
   in some embodiments, a default set of assumption are made for flow execution at step 704—the default assumption can include any one or more of:
   for actions—app install/mobile app install, offsite_conversion, link click, page like, and for engagement actions—pushed out;
Step 705: Data downloading:
   while the data is downloading, show a progress bar (if progress can be calculated);
   the dialog can include text for example “This may take a few minutes. We will send you an e-mail when the download is complete.”;
   in another example, under the progress bar, show a carousel-esque scrolling photo panel of 5 or so advertisement management features;
Step 706: data is downloaded: once the data is imported, an email goes out to the user to let them know the data is imported and they need to come in and complete set up. Also this message appears on screen if the user has not closed the browser window. This Screen shows the sum of total spend Imported, the daily spend for the last 7 days, the number of ads imported, with a breakout of how many of them are “active.” User provide option to move forward “Ok, just one more step”;
Step 707: Review: next a screen shows a review panel with metadata, ad count and spend and the mapped actions (mapped action refer to actions identified by definition on the system as conversion events), and a graph of the last 7 days of spend; option: “Ok, take me to Reporting”;
Step 708: Product Tour- the user is shown Performance Analysis and a light overview via app cues sits on top of New PA that covers: reporting, bidding, budgeting, and additional features offered by the destination system (e.g., Nanigans Ad Engine)

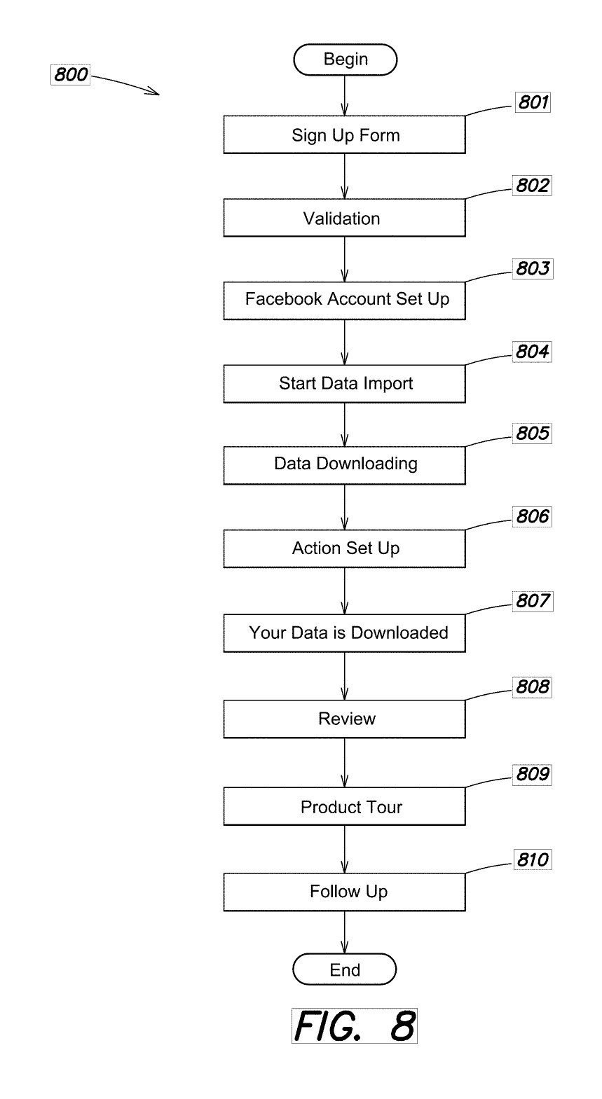

FIG. 8 is a flow chart illustrating another example process flow 800 that describes another use case for advertisement information ingestion. The process flow begins with:
Step 801: sign up form. The form can request name, company, email address, password, site name, vertical, direct or agency, and terms of service to accept. The company name becomes client identifier, site specified name is use to populate the site name filed (also used as application id), email validation email is sent on the completion of this step contains a code. To conclude user is provided option, “Continue Sign Up.”
Step 802: Validation—includes display of an input box for the code that is emailed in the previous step:

Options for “Back” and “Next” are shown—next is grayed out until the input boxes are filled in;
Step 803: FACEBOOK Account Set Up: button for “Link FACEBOOK Account to Ad Engine” is shown;
   one example used oAuth protocols to generated a pop up display to input authentication information for FACEBOOK account and data capture;
   once the account is authorized, the option to Name the account gains focus and an input box is show for name;
   validation that an email address is there;
   user is then show options “Back” and “All Set! Let's keep going”;
Step 804: Start Data Import: display splash page and message “We will now start downloading your Ad Account, this may take a few minutes. We will send you an email when the download is complete”;
   a small hyper link button to toggle advanced options exists;
   advanced options are configured to let the user select time window of data to download. Options are 7, 14, 28 and 90 (in days). An example default is 28 days;
   user shown option “Let's Go!” to continue;
Step 805: data downloading : while the data is downloading, show a progress bar;
   under the progress bar, show a carousel-esque scrolling photo panel of 5 or so destination system features (e.g., Nanigans AdEngine features—performance analytics, cohort, dashboard, etc.);
Step 806: Action Set Up: screen appears for the users to order their FACEBOOK actions to create a light weight funnel (filter);
   example advancement includes a “Select Actions to Track” option shown in display;
   UI can include default order by sum of actions, largest to smallest when presenting the list where users can re-order the actions via drag and drop and trash ones they don't want to insert into tracking orders;
   to continue user shown two options one for “reset” to restores any changes that were done to the order and “Ok, I got it. Let's move on and review everything”;
Step 807: Your Data is downloaded: once the data is imported, an email goes out to the user—summary information can be displayed here to show the sum of total spend imported, the daily spend for the last 7 days, the number of ads imported, with a breakout of how many of them are “active.”;
   example option to advance in flow —select “Ok, just one more step”;
Step 808: Review: next a screen shows a review panel with naming conventions, Ad Count and Spend and the mapped actions;
   example to advance flow—user presented options for “Back” or “Ok, take me to Reporting”;
Step 809: Product Tour—the user can be shown features of the destination management system, including for example, performance analysis and a detailed overview via application cues of reporting functions, bidding, budgeting functions, and additional features offered by the system (e.g., Nanigans' Ad Engine)
Step 810: follow up—upon completion of the wizard (i.e., steps 801-809) the user is placed fully into the product; a “Congratulations Email” is sent and the user can analyze the imported data used the new features provides by the destination advertising management system.

Examples of general data flow elements for ingestions include (any number or combination of the follow elements can be used in various process flows):
a boolean option display requesting download existing (live) ad groups and associated data;
data download options includes trailing time options, 7 days, 14 days, 28 days, and 90 days with default to 28 days;
other examples enable download all data (not time range input);
trigger oAuth 2.0—display a window to grab the username and password; and
authorization process can be implemented to remain on destination system web site, i.e. retrieve data from target systems rather than transition and capture.

In other examples, ingestion process execution can also include universal object creation—to make sure all the meta data tied to a placement exists. For example, data fields created for universal objects can include: Ad Plan (hidden object); “Allocation” (‘Simple’ template), Ad Plan Policy object aka Strategy Group; Budget Pool (new BP—require naming in flow, no daily budget needs to be set in advance); Ad Plan Pricing; Pricing.

In further examples, advertising campaign downloads can include operations to fetch campaign names, id, objective, and status. Adset downloads can include operations to fetch adset names, id, status, budget_cents, start_date,end_date, and parent campaign_id. Once captured, the process can execute mapping operations to find parent data objects in the destination system and associate the preceding fields into a structure table. Query ad group from downloaded information to obtain: ad group end point to find ads and fetch adgroup name, id, status, bid_cents, and objective. Once captured, the process can execute operations to find a parent data object on the destination system and write structure_id row to a placements table and put row in placement_set_links table, as well as placement_relations, and placement_pricings. Additional operations are configured to detect “ad type” (this is in the creative object as define by FACEBOOK). In one example, the system is configured to operate as a reverse compiler to take FACEBOOK specialized data and map it to sets. According to one embodiment, a set is a data model object which includes FACEBOOK's creative and also includes targeting data. Using a broader (i.e. more inclusive data model) enables functionality across a plurality of advertising systems that extend the options available through various conventional systems. When the destination system (e.g., Nanigans' AdEngine) deploys ads, the ads are compiled or pushes from the universal data objects into the FACEBOOK data model. Ingestion reverses this approach and translated FACEBOOK's data model into the universal form of the destination system.

In further examples, responsive to importing creatives (FACEBOOK data object), the system captures: Title, Body, Image, Post Text, Caption, Description, and post id and maps to the universal data object. Also captured and mapped are conversion specification data, tracking specification data, keyword sets and any virtual target creations. Additional details can be captures and mapped, including: page posts, add to Library.opengraph_actions and objects tables based on conversion, specifications and/or tracking specifications.

Other data capture based actions can include:
set Creation
use each element to create records in “sets” table, set_details too . . . and update placement-relations
placement record creation and incorporate assorted links
   Bid, bid type and budget fetch from ad group and campaign
   ad plan set links (site_id, ad_plan_id, set_id, etc.)
create actions
   scan all the “actions” across the graph, create a list of “actions”
   present list of actions in order for the user to select to set up, allow the users to drag and drop them in a stack rank order to create the “funnel” concept
fetch stats: if possible fetch stats in hourly intervals for the select time period, and if not, fetch daily stats and note during the import process hourly stats won't be available historically but will be there going forward.

Historic data may be captured and associated with data structures on the destination system to enable dynamic and interactive displays of the historic data. The interfaces can be configured to merge current data with historic data to facilitate user access to information. The dynamic displays can be responsive to user selection of data dimensions (e.g., information associated with ads, metadata, further information associated with the descriptive information, etc.). In some embodiments, the system generates interfaces that enable easy selection of data dimensions (e.g., right click to add available data dimensions, or drag and drop data descriptors into a visual display). The interfaces can then dynamically generate and redisplay advertisement information as new data dimensions are incorporated, removed, repositions, and/or re-ordered. In some embodiments, the interfaces may be browser-based applications written in a variety of programming language including, but not limited to Java, Javascript, PHP, among others. Such an architecture (e.g., the Data Analytics and Workflow Architecture) may be designed to handle many events in a scalable manner. Raw data may be stored in a relational database (e.g., MySQL) as the vast majority of the data is relational in nature and databases such as MySQL provide ACID transactions.

According to one embodiment, to achieve the performance required and support multi-tier pivoting, the system may be configured to load all of the required MySQL data into memory. In one embodiment, the system may break the information (e.g., data dimensions) into two types:
Placement metadata such as creative, and audience
Performance time based data Placement metadata may be stored in memory and, according to one embodiment, the placement metadata is immutable. Loading this data often requires joins across many tables and can be slow, however, it is appreciated that once in memory, the data can be accessed very quickly. Recent performance data may be kept in memory while older data is retained based on user access. The data may be refreshed regularly, or changes to data may be streamed into the architecture to ensure the query results represent real-time metrics.

A query engine acts upon the data in memory using data agnostic actions (i.e. group, sort, where, having). In one example, because the data volumes for advertising metrics are so large, an infrastructure may be provided that is capable of handling billions of events and aggregating the information into displays that are capable of being acted upon in real time by users (e.g., ad managers). Information may be aggregated and for use in pivot tables that can be presented to users within a management interface. Such pivot tables may access a tree-like data structure having multi-layer aggregation that permits attribute and metric filtering at any layer. To this end, a custom procedural query engine may be provided that is capable of generating this tree-like structure. The infrastructure itself may be underpinned by a dynamically balanced fault tolerant server structure. For example, a load balancer may be provided that distributes load to one or more nodes which performs various functions (such as tree generation/management and SQL operations on a MySQL database).

It is noted that, according to one implementation, the data model and data access layers are completely decoupled from the query engine. The paths given to the query engine refer to fields within the object using reflection and support expressions against those fields. This allows for using the architecture to analyze other future data objects beyond just placements.

The query engine may use a procedural language to process the data. Below is an example:

### GET(1234)

WHERE(EQUAL,placement.audience.minage,15)
GROUP(placement.audience.gender,placement.creative.title)
SORT(0,placement.creative.image,DESC,placement.bidtype,ASC)

### ATTACH(1234,TODAY,HOUR)

HAVING(1,GREATER_THAN,placementperformance.clicks/placementperformance.impressions,0.5)

In this case, placement metadata for site 1234 is utilized and first filters out any placements whose audience's minimum age is 15. The results are then grouped by audience gender and creative title and sorted by image and bid type. Attach then combines metadata with today's time based performance data and groups it by hour. Finally, the having step filters any aggregate data for each hour to only include those whose click through rate is greater than 50%. Data is represented as a tree with aggregate summaries at each non-leaf node. The result is that loading Placement Analysis for a customer in a conventional architecture with 1 million placements would take between 20-30 minutes, while the architecture is capable of executing a more complex query in under 2 seconds.

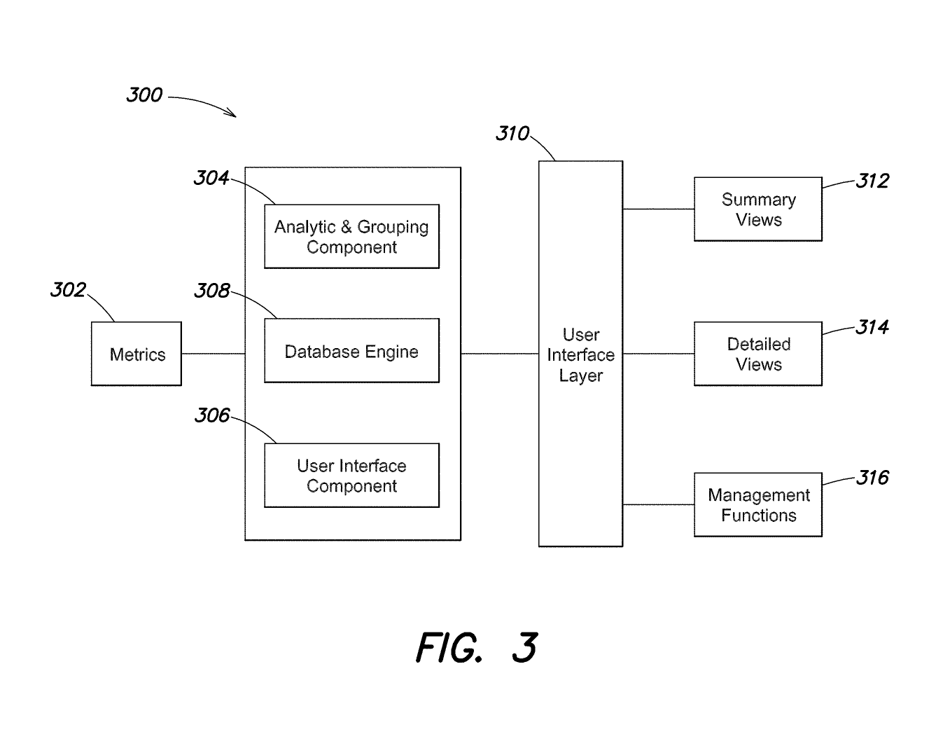

FIG. 3 shows an example of a system 300 for generating and displaying a graphical user interface for high volume data analytics. The system receives advertising metrics 302 from any number of advertising platforms or publishers of advertisements. A data analytic and grouping component 304 is configured to process the received metrics and store the data according to, for example, advertising type, advertising groupings, advertising targets. In one example, the analytic and grouping component captures information on the advertising type, advertising groupings, advertising targets from a database engine 308, determines the appropriate associations, and the database engine stores the associated data and any summarizations or calculations on those values in a database. In one embodiment, the user interface component 306 is configured to provide a visual representation of pivot tables executed against the database. Each view of the database can be likened to a new pivot table, where each view performs specific selections on the database data and presents analysis on the current selections.

According to one embodiment, the system presents a unified user interface layer 310 that is presented to users of the system. The user interface layer 310 is configured to organize and display the variety of summary views 312; and any management functions 316 and/or views.

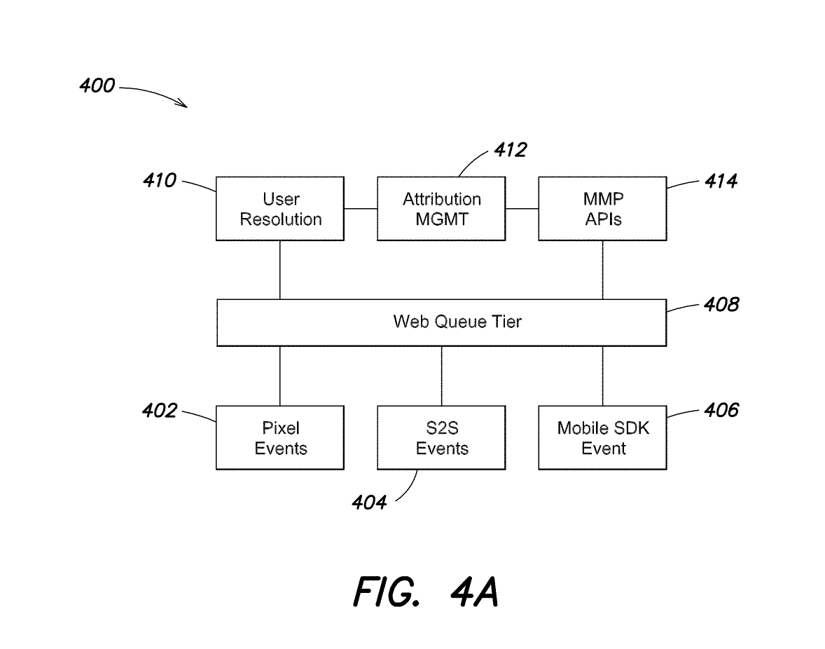

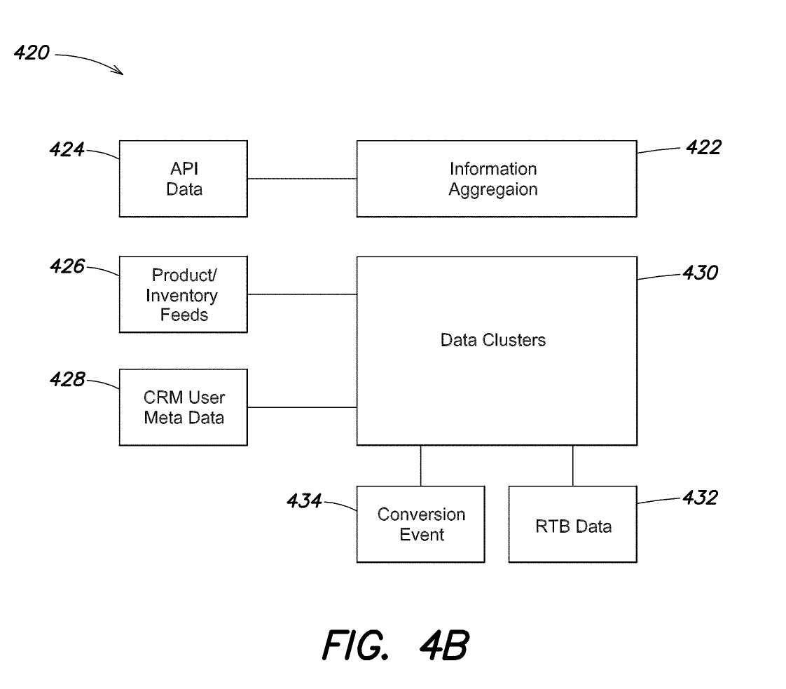

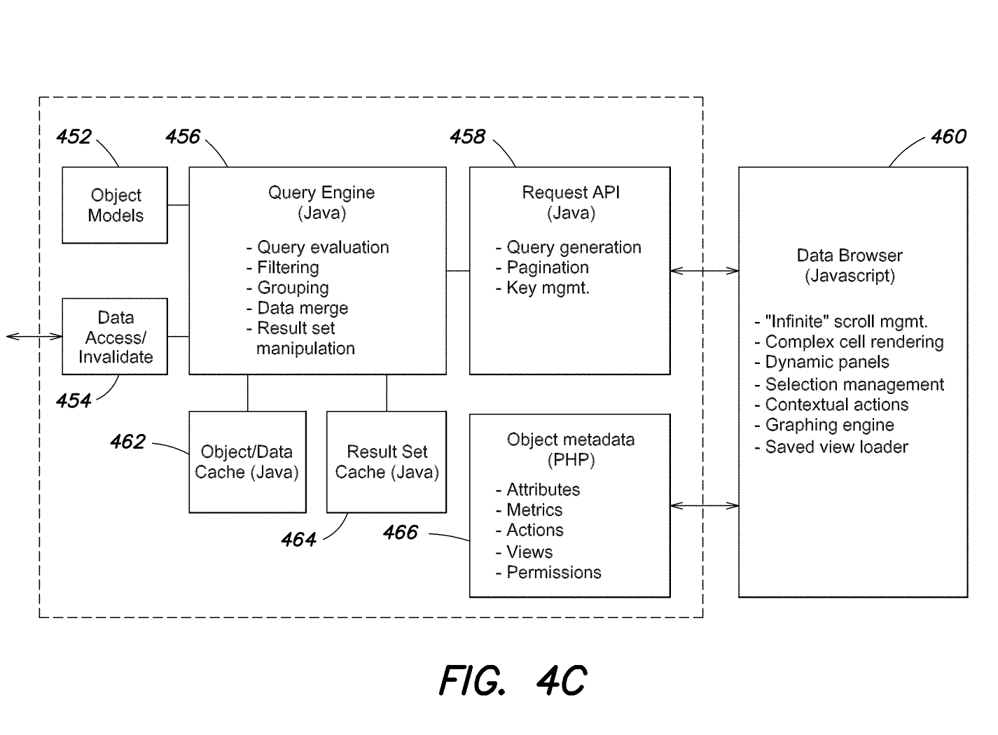

Further, various aspects of the invention may be practiced with one or more advertising automation systems shown by way of example in FIG. 4A-C. In particular, system 400 can be configured for processing high volumes of advertising-related events in a distributed advertising network. Such events may be originated by one or more sources and may be of various types (e.g., pixel events 402, S2S (server to server tracking) events 404, mobile events 406, etc.) that are received and handled by a web queue tier 408. The system may also include various components, such as a component that performs user resolution functions (determining users across multiple platforms e.g., 410), a component that determines attributions 412 (e.g., by observing impression/click histories and tracking conversions/actions), among other functions. The system may have other components, such as components that perform CRM functions, receive product/inventory information, real time structured data (e.g., real time bid (RTB) data (e.g., bids, wins, clicks)), and receives offline conversion events or other information that may be used to analyze performance of particular ads. For instance, there may be components that perform offline analysis of performance data to determine higher level functions, such as optimized bidding and budgeting of ads. In some embodiments, multi-media partners (MMP) and respective application programming interfaces (e.g., MMP APIs 414) can be integrated into the system to facilitate attribution management, data capture, events information, etc.

According to one embodiment, FIG. 4 illustrates an embodiment of a data measurement and attribution layer integrated into the system. The bottom blocks (e.g., 402, 404, 406) illustrate examples of the sources of user interaction data. For example, javascript pixels are used to communicate website interaction events for individual users to the system. In another example, a mobile software development kit (“SDK”) is similarly used to communicate mobile app interactions. In another example, there is also an interface to capture server to server based events, where a server belonging to an advertiser or content provider entity can directly provide respective data to the system.

As illustrated, each of the example sources communicate with a set of servers, for example in the second layer of the figure (e.g., the “web queue tier” at 408). The web queue tier 408 includes globally distributed web servers which provide load distribution, queuing, and cookie management, so that the end user's browser or mobile app is not slowed down waiting for the completion of the attribution process (e.g., data tracking and identification of associated users and/or actions).

In one example the web queue tier is a set of servers implementing user resolution and attribution operations. User Resolution at 410 includes a plurality of servers configured to utilize tokens collected by the data sources to synthesize an internal identifier which is unique to each user. According to one embodiment, the synthesizing of the internal identifier does not connect to identifiable information about that user, but rather provides a way to connect events over time to determine which interaction events should be aggregated together for performance reporting. In Attribution Management 412, a group of servers are configured to evaluate each tracked interaction in light of a respective user's history in order to determine which advertisements or content, if any, should receive credit for causing the interaction. According to one embodiment, the system currently implements a “last touch” attribution model, but others are possible (e.g., first touch attribution model, weighted attribution models, hybrid attribution models, among other options). For mobile app interactions, various embodiment of the system are configured to automatically query other servers via mobile measurement partnership (“MMP”) APIs to determine the best attribution. Based on the data returned form MMP APIs, the system identifies a best attribution (e.g., based on determining a level of influence for each attribution contributor) and stores the attribution information.

According to some embodiments, the user interface layer 310 is configured to generate and present tailored views to end users, where the views include navigable visualizations of advertising data. For example, the user interface layer can generate a user interface that is a data-centric pivot table that allows dynamic navigation into more specific information, such as ad placement information through navigable data representations, wherein each data representation can be selected in the user interface to dynamically alter the data displayed or navigate into further detailed selections.

For example, a user may be presented an interface that allows a user to navigate through performance analysis data (e.g., ad placement performance information) to locate specific ads and their performance within a hierarchical view. The specific ad information that is displayed may include performance information specific to the filters used to navigate to the specific ad. Such an interface is beneficial, as it permits an advertising manager to quickly locate relevant ad placement details through a data-driven interface. In one embodiment, the interface may include the ability to present an inline summary of the ad placement within a tabular view of the performance data. Summary information associated with the displayed ads may be changed depending on the filters or other user selections within the interface. Such capabilities may permit a user (an advertising manager or other user type that manages ad placements) to quickly locate relevant ads within the user interface that relate to the displayed placement performance data.

FIG. 4B illustrates data management system components and functions executed by the system. According to one embodiment, the system 400 is configured to receive, analyze and return processed analytics to online advertisers, by aggregating respective data from the measurement and attribution layer (e.g., illustrated in FIG. 4A). In one embodiment, the system implements a set of specialized servers (e.g., 422) configured to provide information about interactions aggregated by advertisement, attribution time, and interaction time—these aggregations can be referred to as of time cohort rollups which can include aggregation of related information or information that can be grouped based on similarity.

In further embodiments, the system can be configured to combine this information with data drawn from advertising publisher APIs (e.g., 424) and RTB data streams (e.g., 432), as well as various advertiser data sources (e.g., conveying conversion events at 434), such as customer relation management (“CRM”) systems (e.g., 428) and product and inventory feeds (e.g., 426). FIG. 4B illustrates these data sources connecting to a set of data clusters (e.g., 430). In one embodiment, the data clusters 430 include storage systems that provide a variety of mechanisms of access to the integrated data with different performance characteristics suitable for different applications using the data. In one example, a MySql cluster can be configured to support functions and displays of the high volume analytics systems. In another example, the other systems (e.g., Hadoop, Aerospike, etc.) support real-time bidding and performance modeling and optimization.

Various embodiments of the system enable one or more of or any combination of: processing and rendering of analytics on 600 million conversion events each day; globally (DNS) balanced web tier; manage cookies; handle redirects and containers; accept and queue events; user resolution; horizontally scalable processing; multiple tokens and/or levels of authority for accessing and/or visualizing data; device bridging by first party ID; MMP API integrations; bridge click-to-install gap; attribution management—for example, based on user impression/click/event history; in another example attribute is defined by last click but other models possible. Further embodiments enable one or more of or any combination of: processing 600 million conversions/day; 300 thousand RTB events/second; 400 million user records; 300 million feed elements; 30 million MMP API data rows/day; mixed granularity (e.g., by event, user, product, ad time); storing real-time structured data, for user management, attribution, RTB match; execute map/reduce and/or ETL frameworks; which can be used for modeling and exploration; and can include low latency rollups (e.g., information aggregations) which provide merged cohort data with time information, which the system can use for reporting and/or API decisions.

Yet other embodiments are configured to execute one or more or any combination of the following: unique interface paradigm which provides visualization of live performance context data while executing management functions, editing existing placements, etc.; context-specific actions and visualizations for live campaigns and directly integrate live analytics views; fast, configurable analytics interface responsive to user input; API triggering responsive to user interface input; multi-layer, multi-dimensional aggregation of performance/placement data; comprehensive ad attributes and metrics; powerful sorting and filtering in responsive user interface; variable time frames and granularity associated with data aggregates accessible and tunable in the user interface; graphic and tabular views; near real-time reporting (e.g., with hour granularity, minute granularity, etc.); and tailored performance even for large campaigns and wide time windows. Still other embodiments enable one or more of or any combination of: a custom procedural query engine; queries against generic object hierarchy; building result trees with multi-layer aggregation and, for example, loading of tree segments to optimize fast visualization; attribute and metric filtering at any tree layer; persistent result set management;

smart object/data and result set caches to optimize visualizations; pre-loading of frequently used data; object definition and data access plug-ins; client-side data browser and object manager; interfaces to server API for analytics access; smart client-server scrolling (e.g., incremental loading of data); dynamic attribute and metric panels; context/selection-specific action menus and panels; load and pivot ad-level lifetime campaign data visualized in under one second; remains responsive for time-based analysis over GBs of data; and a dynamically load balanced, fault tolerant cluster.

FIG. 4C is an example block diagram showing data analytic components and workflow executions. FIG. 4C shows the same components of the system that enable various features of the system and/or user interface displays. For example, model definitions (e.g., 452) describing the organization of placement metadata (e.g., 466 detailing, for example, how to find the creative elements of an ad from an ad id in a data row) and code to fetch data from the system, as well as provide signals for cache invalidation (e.g., 454) when key data changes. In one example, data is loaded and cached for display in the user interface. The data is cached to facilitate access, while cached, monitoring processes review cached data for changes (e.g., real time data feeds can constantly update data). By invalidating a cached entry or data object the system forces loading of the most up to date information in the user interface, and for example, when the user is accessing administrative functions/Uls, and/or where the real time data in not part of the active display.

In one embodiment, the query engine implements in-memory queries against aggregate advertising data (e.g., loaded from FIG. 4B) stored in an object/data cache (e.g., at 462). The engine can be specialized for flexible dimensional aggregation, such that the underlying (ad, attribution_time, event_time, etc.) data can readily be analyzed based on ad properties and time window aggregates. As the query engine answers queries, it stores results in a result set cache (e.g., 464) so that the results for a specific UI session do not change unexpectedly as data is updated.

The analytics user interfaces cane be implemented through a javascript client side app (e.g., 460) with a corresponding server-side API (e.g., 458) that interfaces with the query engine (e.g., 456). The JS app issues data requests to the API (e.g., 458) as users configure aggregation, filtering, and date range settings, and then manages data fetched via the API from the matching result sets to provide high performance on the client while operating within reasonable client memory limits.

According to one aspect, the user interface is specially configured to manage, aggregate, and dynamically select data for visualization responsive to constantly updating data feeds (e.g., live placement data associated with an advertising network). The dynamic nature of the received data allows a user to selectively control their view of the changing data, for example by creating and saving user interface views. In one implementation, a database management component is configured to receive the dynamic data feeds, translate the dynamic data feeds into standardized formats, and group the dynamic data into selectable and displayable elements. According to another aspect of the present invention, a visualization interface may be provided that includes a web-enabled pivot table used to analyze and present ad performance data. According to one embodiment, advertisers may use a pivot table to view, sort through, and visualize multiple dimensions of advertising or groups of advertising data. Such tables, according to various embodiments, are configured with the attributes and metrics that are specifically tailored to user's needs by adding predefined audiences, creative elements, data- related attributes or placement details, followed by the metrics that determine campaign success. Once the selections within the interface have been made, the user may be permitted to simply drag and drop displayed elements to re-order metrics and/or to create a customized campaign dashboard. Such interfaces may be modified to include a summary view associated with a specific ad within the table based on specific user selections within the pivot table. This permits, for example, a user to selectively create a dashboard using certain metrics while at the same time seeing the specific ad placements and their associated summaries according to the configured dashboard. For instance, if an advertiser wants to see which creative was performing the best, the user is permitted to sort by key metrics (e.g., ROI, LTV, CTR, CPC, etc.) and locate specific summary view information relating to those placements.

In various embodiments, the system includes a predictive, analytics, and optimization executables interposed between an advertisement representation layer and the campaign configuration layer. The predictive, analytics, and optimization layer may be configured to provide one or more advertisement parameter suggestions automatically. In various embodiments the destination format is configured to enable predictive optimizations on the execution and management of individual placements, budget pools, strategy groups, and entire advertising campaigns. In some embodiments, after ingesting advertising campaigns, a new management system can operate on historical data to predict performance and/or optimize execution of advertisements and/or make one or more suggestions. Automation enables the system to distinguish between ads that have good value (methods and systems for determining value are described in Co-Pending U.S. patent application Ser. No. 14/324,992, entitled PREDICTING CONSUMER LIFETIME VALUE, filed on Jul. 7, 2014, which is incorporated by reference herein in its entirety), and ads that are likely throwing money away—equally important, in some examples, is that the system can convey high volumes of data to an end user, understandably and manageably, through customized displays.

The system and Uls provided enable definition of advertising parameters for any ad placement. The UI can include contextual displays of a plurality of existing placements and the associated data can be captures and used to population data fields for the parameters for an ad placement. As the parameters are defined they can be passed through a gatekeeper server, which can be configured to reduce the received parameters to a core ad or placement representation, which can be used to establish a management ad representation configured to enable management of a plurality of channel specific ads or placements and/or associated functions, where the placements can be generated from the core representation. In one example, the management placement representation is configured to enable management across, for example FACEBOOK via an API, FACEBOOK EXCHANGE, MOPUB, TWITTER, etc. Each modification to the placement and/or execution of a management function (e.g., bid up, bid down, pause, re-target audience, re-deploy placement, etc.) can return performance information from the respective channels and map to data structures native to the ingestions system. The UI can be configured to visualize the returned information, for example, using the management placement representation.

According to some embodiments, historical data can take a while to ingest, and the machine learning model is configured to wait until the data is available. In some example accounts take less than a day to ingest, although large accounts can take substantially longer. According to some embodiments, data analysis is available for whatever data has completed ingest (e.g., a complete advertisement has been ingested) as the ingest is in process, but the system is configured to provide automatic operations as recommendations until the entire ingestion process has been completed. In another embodiment, the user can specify on the system, and the system is configured to automatically control, advertisements as they are ingested (and entire ingestion not complete), an options for the system to take over automatic control during ingestion.

For example, according to one embodiment, an interface may be provided that is a data-centric pivot table that allows dynamic navigation into more specific information, such as ad placement information. For instance, a user may be presented an interface that allows a user to navigate through performance analysis data (e.g., ad placement performance information) to locate specific ads and their performance within a hierarchical view. The specific ad information that is displayed may include performance information specific to the filters used to navigate to the specific ad. Such an interface is beneficial, as it permits an advertising manager to quickly locate relevant ad placement details through a data-driven interface. In one embodiment, the interface may include the ability to present an inline summary of the ad placement within a tabular view of the performance data. Summary information associated with the displayed ads may be changed depending on the filters or other user selections within the interface. Such capabilities may permit a user (an advertising manager or other user type that manages ad placements) to quickly locate relevant ads within the user interface that relate to the displayed placement performance data.

Various aspects and functions described herein may be implemented as specialized hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry

Limited, and Windows Phone devices. Further, aspects may be located on a single computer system or may be distributed among a plurality of computer systems connected to one or more communications networks.

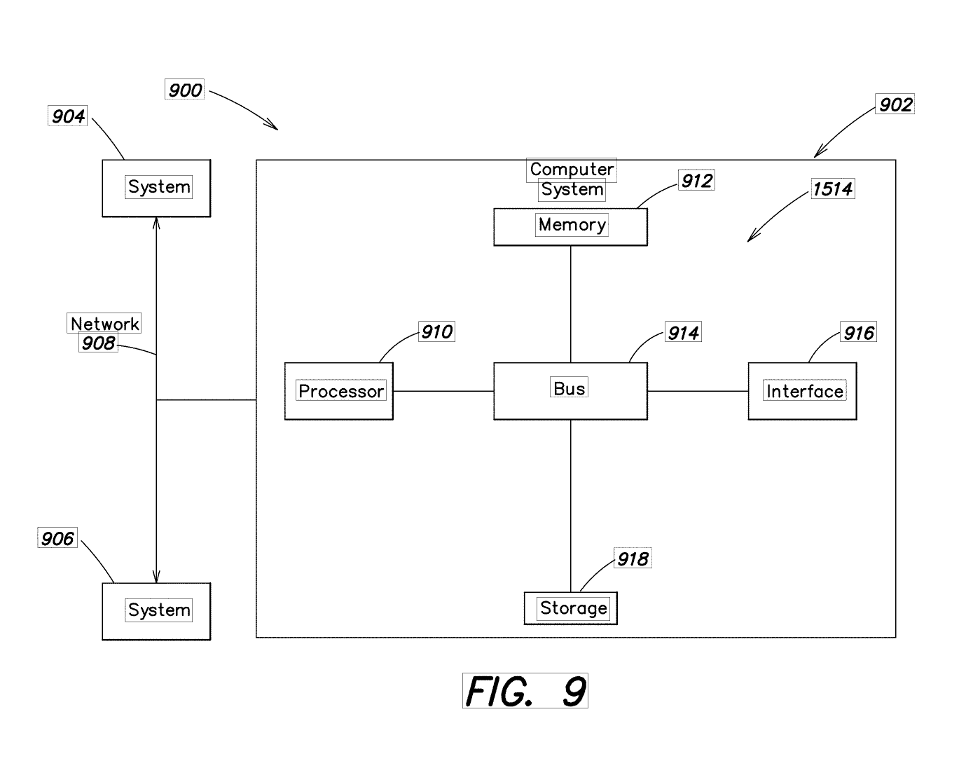

For example, various aspects, functions, and processes may be distributed among one or more computer systems configured to provide a service to one or more client computers, or to perform an overall task as part of a distributed system, such as the distributed computer system 900 shown in FIG. 9. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 9, there is illustrated a block diagram of a special purpose distributed computer system 900, in which various aspects and functions are practiced. As shown, the distributed computer system 900 includes one or more computer systems that exchange information. More specifically, the distributed computer system 900 includes computer systems 902, 904, and 906. As shown, the computer systems 902, 904, and 906 are interconnected by, and may exchange data through, a communication network 908. The network 908 may include any communication network through which computer systems may exchange data. To exchange data using the network 908, the computer systems 902, 904, and 906 and the network 908 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 902, 904, and 906 may transmit data via the network 908 using a variety of security measures including, for example, SSL or VPN technologies. While the distributed computer system 900 illustrates three networked computer systems, the distributed computer system 900 is not so limited and may include any number of computer systems and computing devices, networked using any medium and communication protocol.

As illustrated in FIG. 9, the computer system 902 includes a processor 910, a memory 912, an interconnection element 914, an interface 916 and data storage element 918. To implement at least some of the aspects, functions, and processes disclosed herein, the processor 910 performs a series of instructions that result in manipulated data. The processor 910 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 910 is connected to other system components, including one or more memory devices 912, by the interconnection element 914.

The memory 912 stores programs (e.g., sequences of instructions coded to be executable by the processor 910) and data during operation of the computer system 902. Thus, the memory 912 may be a relatively high performance, volatile, random access memory such as a dynamic random access memory (“DRAM”) or static memory (“SRAM”). However, the memory 912 may include any device for storing data, such as a disk drive or other nonvolatile storage device. Various examples may organize the memory 912 into particularized and, in some cases, unique structures to perform the functions disclosed herein. These data structures may be sized and organized to store values for particular data and types of data.

Components of the computer system 902 are coupled by an interconnection element such as the interconnection element 914. The interconnection element 914 may include any communication coupling between system components such as one or more physical busses in conformance with specialized or standard computing bus technologies such as IDE, SCSI, PCI and InfiniBand. The interconnection element 914 enables communications, including instructions and data, to be exchanged between system components of the computer system 902.

The computer system 902 also includes one or more interface devices 916 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 902 to exchange information and to communicate with external entities, such as users and other systems.

The data storage element 918 includes a computer readable and writeable nonvolatile, or non-transitory, data storage medium in which instructions are stored that define a program or other object that is executed by the processor 910. The data storage element 918 also may include information that is recorded, on or in, the medium, and that is processed by the processor 910 during execution of the program. More specifically, the information may be stored in one or more data structures specifically configured to conserve storage space or increase data exchange performance. The instructions may be persistently stored as encoded signals, and the instructions may cause the processor 910 to perform any of the functions described herein. The medium may, for example, be optical disk, magnetic disk or flash memory, among others. In operation, the processor 910 or some other controller causes data to be read from the nonvolatile recording medium into another memory, such as the memory 912, that allows for faster access to the information by the processor 910 than does the storage medium included in the data storage element 918. The memory may be located in the data storage element 918 or in the memory 912, however, the processor 910 manipulates the data within the memory, and then copies the data to the storage medium associated with the data storage element 918 after processing is completed. A variety of components may manage data movement between the storage medium and other memory elements and examples are not limited to particular data management components. Further, examples are not limited to a particular memory system or data storage system.

Although the computer system 902 is shown by way of example as one type of computer system upon which various aspects and functions may be practiced, aspects and functions are not limited to being implemented on the computer system 902 as shown in FIG. 9. Various aspects and functions may be practiced on one or more computers having a different architectures or components than that shown in FIG. 9. For instance, the computer system 902 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 902 may be a computer system including an operating system that manages at least a portion of the hardware elements included in the computer system 902. In some examples, a processor or controller, such as the processor 910, executes an operating system. Examples of a particular operating system that may be executed include a Windows-based operating system, such as, Windows NT, Windows 2000 (Windows ME), Windows XP, Windows Vista or Windows 7, 8, or 10 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 910 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using

HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for generating build templates comprising:
at least one processor operatively connected to a memory, the at least one processor when executing, is configured to:
receive selection of a group of placements in a user interface;
decompose the selected group of placements into components that make up the placements;
generate a build template executable by the system that when executed causes the system to create the selected group of placements, wherein the system captures any defined parameters specified by the selected group of placements and incorporates the parameters into the build template or associated element of the build template;
identify elements of the build template such that responsive to combining the elements of the build template in every permutation only the selected advertisements or a subset of the selected advertisements are defined;
provide interactive access to the build template through the user interface to manage and modify the selected group of advertisements or the subset of the selected advertisements based on selections in the user interface to modify the build template or build template parameters.

2. The system of claim 1, wherein the at least one processor is configured to re-generate a group of advertisements corresponding to the permutations of the modified build elements responsive to generation of the build template and the build template parameters.

3. The system of claim 2, wherein the at least one processor is configured to display the build template in the user interface, wherein responsive to selection in the user interface, the build template and build template parameters are accepted, modified, delete, or updated with additional elements or parameters.

4. The system of claim 1, wherein the system is further configured to:
identify elements of a first build template such that responsive to combining the elements of the build template in every permutation only a first subset of the selected advertisements are defined;
identify elements of at least a second build template such that responsive to combining the elements of the second build template in every permutation only a second subset independent of the first subset of the selected advertisements are defined.

5. The system of claim 4, wherein the system is configured to identify elements of additional build templates until each advertisement in the selected group is represented by a respective build template.

6. The system according to claim 1, wherein the system is configured to use authentication information and access placement data stored in a first data format and map the placement data to a destination data format;
automatically create corresponding placements associated with the placement data and execution parameters for respective placements; and
generate one or more build templates associated with the automatically created corresponding placements.

7. The system of claim 6, wherein the system is further configured to manage, automatically, the respective placements with the ingestion subsystem, wherein managing the respective placements includes an act of communicating by the at least one processor operation instructions to the first service provider that trigger the first service provider system to control the placement on the first provider system.

8. The system according to claim 1, wherein the system is further configured to enable dynamic generation of performance information responsive to user selection of data dimensions in the user interface.

9. The system according to claim 8, wherein the system is further configured to generate performance information on multi-dimensional groupings of the placement data responsive to selection in the user interface.

10. The system on claim 1, further comprising a user interface (“UI”) component configured to display high volume data analytics.

11. The system of claim 10, wherein the UI component is further configured to:
receive historical placement metrics;
analyze and group the historical placement metrics into an placement demographic hierarchy configured for display in a selectable visual interface.

12. The system of claim 11, wherein the UI component is further configured to dynamically generate visual displays on the historical placement metrics responsive to user selection of information dimensions associated with one or more advertisements in the selectable visual interface.

13. The system of claim 10, wherein the UI component is configured to display information dimensions associated with advertisements in a selectable pivot table display.

14. The system of claim 10, wherein the UI component is further configured to:
receive current placement metrics;
analyze and group the current placement metrics into an placement demographic hierarchy configured for display in a selectable visual interface.

15. The system of claim 11, wherein the UI component is further configured to dynamically generate visual displays on the historical placement metrics responsive to user selection of information dimensions associated with one or more advertisements.

16. The system of claim 15, wherein the UI component is further configured to dynamically generate visual displays on historical placement metrics imported from outside providers in conjunction with current placement metrics on advertisements managed by a destination system.

17. The system of claim 16, wherein the UI component is further configured to dynamically generate the visual displays of historic and current placement metrics responsive to user selection of information dimensions associated with one or more advertisements.

18. The system of claim 15, wherein the UI component is further configured to display summary information for the placement metrics in each level of an placement demographic hierarchy.

19. The system of claim 18, wherein the UI component is further configure to generate a navigable user interface display including at least one selectable drawer associated with a hierarchical group of placement metrics, wherein the at least one selectable drawer includes a display of a title of a respective hierarchical group; and wherein the at least one selectable drawer is associated with a respective summary view of the placement metrics within the hierarchical group.

20. The system of claim 1, wherein the at least one processor is further configured to: access the placement data via an placement API associated with a social networking provider.
